(19) United States
(12) Patent Application Publication
(10) Pub. No.: US 2022/0355262 A1
(43) Pub. Date: Nov. 10, 2022

(54) SYSTEM AND METHOD FOR MANUFACTURING WATER-BASED HYDROPHOBIC AEROGELS AND AEROGEL COMPOSITES

(71) Applicant: KROSSLINKER PTE LTD, Singapore (SG)

(72) Inventors: Mahesh SACHITHANADAM, Singapore (SG); Elmira KHORASGANI SOGHRATI, Singapore (SG); Gayathri NATARAJAN, Singapore (SG)

(21) Appl. No.: 17/629,212

(22) PCT Filed: Jul. 22, 2020
(86) PCT No.: PCT/SG2020/050425

§ 371 Date: Jan. 21, 2022

(30) Foreign Application Priority Data
Jul. 22, 2019 (SG) 10201906760W

(51) Int. Cl. B01J 13/00; C08J 9/28; C08J 3/24; C08J 9/00

(52) U.S. Cl. CPC B01J 13/0091; C08J 9/28; C08J 3/24; C08J 9/0066; C08J 2205/026; C08J 2201/026; C08J 2389/00; C08J 2383/04

(57) ABSTRACT

Embodiments of the present invention provide users with a system and method for manufacturing water-based hydrophobic aerogels and aerogel composites. The system and method can be carried out in a manner which is more rapid than typical ways and can be readily scalable. The method of manufacture is useful for producing water based hydrophobic aerogels and aerogel composites on a large scale with good homogeneity and consistency. Advantageously, the method of manufacture also has the benefit of a shorter processing time due to the vacuum homogenizing and mixing processes, the use of microwave assisted vacuum freeze drying for ease of synthesis of water-based hydrophobic aerogels.

### FIELD OF INVENTION

The present invention relates to a system and method for manufacturing water-based hydrophobic aerogels and aerogel composites.

### BACKGROUND

Aerogels are a class of 3D networked advanced material with a high specific surface area, low-density, meso or nanoporous structure with excellent thermal and acoustic insulation properties. Aerogels can be considered as the solid backbone of gel separated from the liquid component. Given the variety of different chemistries capable of yielding wet-gels, aerogels and composite aerogel materials can be applied in a wide range of applications. Aerogels can be made from diverse organic, inorganic substances—including but not limited to polymer, carbon, silica, metal and chalcogens. It comes in a variety of forms such as monolith, powder, particles, granules, blankets and board/panel composites. The low solid mass content (˜90-98% air), small pore size (20-100 nm) and tortuous path of heat transfer through the complex network and are the main reasons behind the excellent thermal insulative properties.

The most critical and challenging aspect in aerogel manufacturing is the drying method that is employed where wet gels transform to aerogels. During this drying phase, the liquid is typically replaced with gas (air) under conditions where there is no vapor-liquid phase. Under such conditions, there is an absence of surface tension and capillary forces on the gel, correspondingly preventing collapse of pore structure.

Silica based aerogels currently have the highest market share by aerogel material type for industrial insulation applications. This can be attributed to their low thermal conductivity, low density, good strength-to-weight, non corroding, light-diffusing and hydrophobic properties. There is also increasing popularity in organic aerogels including carbon, graphite, cellulose and polymer as the base material. To achieve the desired properties for commercial applications, the majority of the aerogel products are produced as composites by reinforcing with fibers, polymers, metals and other organic/inorganic reinforcements. Such additional reinforcement materials are added in the gelation process or by introducing the aerogel in granules or powder form into the fiber composite. Despite suitability for use as insulation materials, aerogels have been slow to be commercialised due to issues in manufacturing processes and formulations.

Commercial aerogels are typically produced by supercritical drying, ambient pressure drying and traditional or conventional freeze drying. Though supercritical drying yields the best quality, the capital investment and the amount of precursors used in the method are extremely expensive. Further, they are limited to batch processes. Ambient pressure drying offers an alternative to supercritical drying with better scalability for large scale production. However, ambient pressure drying requires a longer time and an expensive solvent exchange step prior to drying. Freeze drying offers the cheapest capital investment and arguably the greenest method of the three. However, the energy consumption associated with freeze drying and multiple processing steps are impediments for large-scale production. Further, there are thickness limitations to each of the drying methods where it becomes increasingly uneconomical due to higher consumption of expensive precursors used, raw materials used and overall energy footprint. The three methods are usually combined with one or more pre- and post-drying processes that further production raises the production cost. Overall, the existing traditional manufacturing processes are cost-prohibitive for wide-scale adoption of aerogel due to high production cost arising out of inefficiency, complexity, long production time, high energy consumption. Additionally, besides cost, the synthesis and methods of current manufacturing may involve high amounts of hazardous solvents, reagents and liquid carbon dioxide impacting the environment and carbon footprints significantly.

Though several new aerogel formulations have been experimented and commercialised in the last decade, there are several challenges to be resolved on the formulation front. Firstly, optimizing complex parameters in aerogel composite products (such as choice of precursors, binders, crosslinkers used, the molar ratio, pH levels, catalysts, gel points) that are needed to impart specific functionalities (such as fire-retardancy, hydrophobicity) without compromising the unique properties of aerogel still remains challenging. Secondly, the necessity that the formulation and process needs to be in tandem, creates additional inflexibility to produce different forms of quality aerogel products to suit different applications. For instance, rigid aerogel boards are difficult to be fabricated in typical cylindrical reactor vessels used in supercritical drying processes. Thirdly, inhomogeneous distribution and aggregative behaviour of incorporated materials negatively affect the property and quality of aerogel composite especially at manufacturing scale. Fourthly, inherent dust from particle loss and fragility/brittleness challenges in formulation impose limitations on transportation, handling, application and operational lifetime of the material. Further, dust poses a general health and environmental threat during application of these materials on site or in-situ and deteriorates the insulation performance over time.

There is a clear need for developing a novel aerogel production process that is commercially feasible for wide-scale adoption of aerogels across different main-stream industries such as building and construction, cold chain food and pharmaceutical packaging and logistics, marine, industrial, aerospace and automotives that require high-performance insulation material. The fabrication process of aerogels and aerogel composites must be simple, efficient with faster turnaround and lower capital and operational costs. Further, the production technology should be an eco-friendly method and have a low energy consumption. This must be accompanied by significant improvements in properties and eco-friendly aspects of aerogel product formulation development to meet the requirements of existing applications better and also to cater to new applications.

### SUMMARY

In a first aspect, there is provided a method for manufacturing water-based hydrophobic aerogels and aerogel composites, the method comprising:
synthesizing an aqueous binder mixture;
adding silyl modified precursors to form an emulsion;
forming a gelled composite under vacuum homogenizing conditions;
treating the gelled composite hydrophobically;
freezing the gelled composite;
microwave assisted vacuum freeze-drying the gelled composite to form an aerogel composite; and
curing the aerogel composite.

It is preferable that the microwave assisted vacuum freeze drying is configured to induce bulk drying of the gelled composite.

In a second aspect, there is provided a water-based hydrophobic aerogels and aerogel composites manufactured by a method comprising:
synthesizing an aqueous binder mixture;
adding silyl modified precursors to form an emulsion;
forming a gelled composite under vacuum homogenizing conditions;
treating the gelled composite hydrophobically;
freezing the gelled composite;
microwave assisted vacuum freeze-drying the gelled composite to form an aerogel composite; and
curing the aerogel composite.

It is preferable that the microwave assisted vacuum freeze drying is configured to induce bulk drying of the gelled composite.

In a final aspect, there is provided a water based hydrophobic aerogel composite comprising:
a silyl modified aerogel precursor system;
a surfactant;
fire retardants;
hydrophobic agent; and
a crosslinking agent.

It is preferable that the components are homogeneously distributed.

It will be appreciated that the broad forms of the invention and their respective features can be used in conjunction, interchangeably and/or independently, and reference to separate broad forms is not intended to be limiting.

### DESCRIPTION OF FIGURES

A non-limiting example of the present invention will now be described with reference to the accompanying drawings, in which:

FIG. 1 is a flow chart of a general method for manufacturing the aforementioned forms of aerogels;

FIG. 2 is a schematic view of a microwave assisted vacuum freezer dryer used in the present invention;

FIG. 3 is a graph illustrating the amount of moisture balance in aerogel as a function of time;

FIG. 4 is a flow chart of a first embodiment of a method for manufacturing a silica aerogel composite;

FIG. 5 is a flow chart of a second embodiment of a method for manufacturing a silica aerogel composite;

FIG. 6 is a flow chart of a first embodiment of a method for manufacturing a silica reinforced polymer aerogel composite;

FIG. 7 is a flow chart of a first embodiment of a method for manufacturing a cellulose aerogel composite;

FIG. 8 is a flow chart of a first embodiment of a method for manufacturing a silica reinforced cellulose aerogel composite;

FIG. 9 is a flow chart of a second embodiment of a method for manufacturing a silica reinforced cellulose aerogel composite;

FIG. 10 is a flow chart of a first embodiment of a method for manufacturing a silica reinforced nanocellulose aerogel composite;

FIGS. 11A, 11B show examples of completed objects resulting from the aforementioned methods;

FIGS. 12A to 12D shows examples of water contact angle images of end products; and

FIGS. 13A to 13G show examples of microstructural images of end products of the methods of FIGS. 4 to 10.

### DETAILED DESCRIPTION

Embodiments of the present invention produce high quality aerogel and aerogel composites improving on the limitations of current methods and can be replicated for large scale production an adaptable setup that is economical and commercially viability.

Microwave assisted vacuum freeze drying technology (MAVFD) is utilised in the present invention. MAVFD is both a green and low power consuming technology providing a clear advantage over other commercial methods used in manufacturing aerogels. Advantageously, it eliminates the issues of low drying rate, prolonged drying duration, high power consumption, design complexities and high manufacturing setup that are usually associated with conventional freeze drying technology. MAVFD is a high efficiency non-ionising radiation thermal energy technology in combination with vacuum freeze drying technology that allows sublimation of ice to gas under the action of three dimensional microwave field inducing volumetric heating in aerogels. In contrast to layer by layer drying of traditional freeze dryers, the MAVFD allows greater penetration depth throughout the material and thus the drying cycle is extremely fast and efficient.

The present invention also discloses the integrated process of manufacturing the aerogels from the precursors right to the finished aerogel product in a seamless manufacturing process. This allows for easy implementation of a scaled up manufacturing setup. Advantageously, the invention allows for manufacturing a wide range and various types of aerogels from organic to inorganic, from polymeric to biodegradable aerogels.

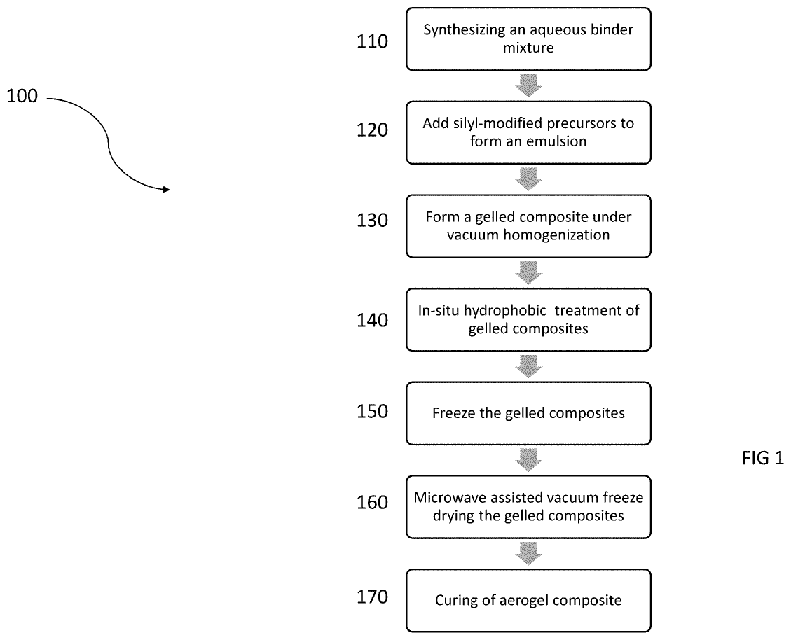

Embodiments of the present invention provide users with a system and method for manufacturing water-based hydrophobic aerogels and aerogel composites. The system and method can be carried out in a manner which is more rapid than typical ways and can be readily scalable. Advantageously, the method of manufacture is useful for producing water based hydrophobic aerogels and aerogel composites on a large scale with good homogeneity and consistency. Advantageously, the method of manufacture also has the benefit of a shorter processing time due to the vacuum homogenizing and mixing processes, ease of synthesis, the use of non-ionising radiation energy in microwave assisted vacuum freeze drying (MAVFD) for rapid drying, curing and due to the addition of a crosslinking agent. FIG. 1 shows the general method of manufacturing of water based hydrophobic aerogels and aerogel composites.

The flowchart diagram shown in FIG. 1 discloses a general example of a method 100 to manufacture the aforementioned forms of aerogels. As mentioned, the manufacturing scalability of the present invention distinguishes it from lab scale production. The method 100 comprises firstly synthesizing an aqueous mixture (110). The aqueous mixture can comprise a water-based binder, fire retardants, fillers and a surfactant. Secondly, a silyl-modified precursor is added to the aqueous mixture to form an emulsion (120). A gelled composite is formed under vacuum homogenization (130). The step 130 is carried out by addition of a water soluble crosslinking agent to the emulsion. Thereafter, in-situ functionalization of the gelled composite is accomplished by infusing water soluble hydrophobic agents to the gelled composite (140). The hydrophobized gelled composite is then frozen (150). The frozen gelled composite undergoes microwave assisted vacuum freeze drying at a first pre-determined pressure and at a first pre-determined temperature (160), the microwave assisted vacuum freeze drying being carried out to an extent that is sufficient for sublimation of ice to occur during bulk drying of the gelled composite. Subsequently, the aerogel composite is cured (170).

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described. For the purposes of the present invention, the following terms are defined below.

The term “aqueous mixture” used herein refers to a water based solvent or solvent system, and which comprises mainly water. Such solvents can be either polar or non-polar, and/or either protic or aprotic. Solvent systems refer to combinations of solvents which result in a final single phase. Both ‘solvents’ and ‘solvent systems’ can include, and is not limited to, pentane, cyclopentane, hexane, cyclohexane, benzene, toluene, dioxane, chloroform, diethyl ether, dichloromethane, tetrahydrofuran, ethyl acetate, acetone, dimethylformamide, acetonitrile, dimethyl sulfoxide, nitromethane, propylene carbonate, formic acid, butanol, isopropanol, propanol, ethanol, methanol, acetic acid, ethylene glycol, diethylene glycol, 1,4 dioxane, tert-butanol or water. In most embodiments, the aqueous solution is water. In some embodiments, the aqueous mixture is deionised water. In some embodiments, the aqueous solution is Millipore water.

An aqueous mixture is advantageously used in the present disclosure. In particular, water is used. Water can be evaporated or sublimed from an aqueous solution via microwave heating through controlled pressure and temperature making it the most green, desirably non-hazardous and non-toxic solvent to be used. The microwave is part of the non-ionising radiation electromagnetic spectrum that can be absorbed into bodies of low di-electric constant such as water, ice, silica, cellulose in nano to micro range and in powders to fibers, polyurethane and generally insulating materials. Since water does not penetrate affect the networked structure of the aerogels, the hydrophobic properties of the aerogels are not compromised.

The term “silyl modified” refers to any entity which is modified with one or more silyl group (-SiR3 where R comprises at each occurrence is independently a C₁-C₆ alkyl group). For example, the functional groups can be in various forms such as methyl, linear alkyl, branched alkyl, fluorinated alkyl, dipoal and aryl.

The term “precursor” refers to a substance from which another substance is formed. Precursors in this invention refers to the starting material such as silanes, cellulose, polymers from which aerogels are made. They are often the building blocks of constant chemical reactions forming a complex and three dimensional interconnected network of molecules.

The term “binder” refers to a substance that holds or draws other materials together to form a single entity.

Binders can be organic or inorganic substances, and can be a liquid or a solid. Without wanting to be bound by theory, it is believed that binders draw materials together by either physical or chemical interactions or both. As used herein, “water based binder” is hence binder which is at least substantially soluble in an aqueous medium. Examples of inorganic binder may include, but not limited to silicone-based, siloxane-based, silicate-based resins or mixture thereof. Examples of organic binder may include, but not limited to, poly((meth)acrylic acid), poly((meth)acrylic ester), poly((meth)acrylamide), polyurethane, polystyrene, poly(alpha-methyl styrene), poly(butadiene), poly(vinyl acetate), poly(vinylidene fluorides), poly (vinylidene chlorides), poly(acrylonitrile), poly(vinyl sulfone), poly(vinyl sulfides), and poly(vinyl suloxides) and their copolymer or mixture thereof. The term “copolymers” as used herein is meant polymers having two or more different monomer units—including terpolymers and polymers having 3 or more different monomers. The copolymers could be random, block, gradient or of other architectures. Monomer units may include, but not limited to acrylic, polyfunctional isocyanate, polyfunctional alcohol (polyol), styrene, alpha-methyl styrene, butadiene, vinyl acetate, vinylidene fluorides, vinylidene chlorides, acrylonitrile, vinyl sulfone, vinyl sulfides, and vinyl suloxides.

The term “surfactant” refers to a substance which tends to lower the surface tension of a liquid. Surfactants are usually, but not limited to, organic compounds that are amphiphilic. As such, the term “surfactants” include within its definition, ionic surfactant, non-ionic surfactant, anionic surfactant, cationic surfactant, amphoteric surfactant or a mixture thereof. Examples of non-ionic surfactant may include, but not limited to, alcohol ethoxylates (based on lauryl alcohol), (oleic acid) and sugar alcohol sorbitol (sorbitan oleate) blends, polyalkylene oxide block copolymer, ethoxylated polyoxypropylene or mixtures thereof. Examples of an anionic surfactant may include, but are not limited to, sodium dodecyl sulfate (SDS), sodium pentane sulfonate, dehydrocholic acid, glycolithocholic acid ethyl ester, ammonium lauryl sulfate and other alkyl sulfate salts, sodium laureth sulfate, alkyl benzene sulfonate, soaps, fatty acid salts, sodium dihexyl sulfosuccinate, polyoxyethyene (5) tridecyl mono/di-phosphate, napthalene sulfonate or mixtures thereof. Examples of a cationic surfactant may include, but are not limited to, cetyl trimethylammonium bromide (CTAB), dodecylethyldimethylammonium bromide (D12EDMAB), didodecyl ammonium bromide (DMAB), cetylpyridinium chloride (CPC), polyethoxylated tallow amine (POEA), hexadecyltrimethylammonium p-toluenesulfonate, benzalkonium chloride (BAC), benzethonium chloride (BZT), quaternary ammonium salts, cetyl trimethyl ammonium chloride and mixtures thereof. Examples of an amphoteric surfactant may include, but are not limited to, dodecyl betaine, sodium 2,3-dimercaptopropanesulfonate monohydrate, dodecyl dimethylamine oxide, cocamidopropyl betaine, 3-[N,N-dimethyl (3-palmitoylaminopropyl)ammonio]-propanesulfonate, coco ampho glycinate and mixtures thereof.

The term “fire retardant” refers to a substance that is used to slow or stop the spread of fire or reduce its intensity. This is commonly accomplished by chemical reactions that reduce the flammability of fuels or delay their combustion. Fire retardants may also cool the fuel through physical action or endothermic chemical reactions. Fire retardants are available as powder, coatings, gels and sprays. In the present invention, fire retardant compounds are used as part of emulsion to impart the property on a as dried aerogel. Examples of fire retardant materials include calcium silicate, sodium silicate, borax, boric acid, zinc borate and sodium decahydrate tetraborate.

The term “crosslinking agent” refers to a substance that contains two or more ends capable of interacting with specific groups on other substances. The interaction enables formation of covalent bonds or short sequences of chemical bonds to join two or more substances or groups by means of physical or chemical interaction. Crosslinking can be facilitated by curing methods at ambient to elevated temperatures and/or by physical adhesions. The crosslinking agent may form linear or grafted networks or combinations of both

As used herein, the term “aerogel” has the common meaning as would be understood by the person skilled in the art. Aerogel refers to a synthetic, porous ultralight material which is derived from a gel, in which the liquid component in the gel has been replaced with a gas or air. Aerogels are usually produced by replacing the liquid component of the gel with gas or air pockets through known drying techniques without causing the solid matrix to collapse from capillary action. As a result, aerogels have a porous solid matrix network containing more than 90% air or gas by volume. Preferably, more than 95% of the volume of the aerogel is gas or air. Even more preferably, more than 98% of the volume of the aerogel is gas or air.

As used herein, “water based aerogel” refers to an aerogel that has the features of above by using water or any other water based solvents as a carrying medium for the solution gelation reaction.

As used herein, “silica aerogel” refers to an aerogel which has silica as a base component. In the simplest form, silica is an oxide of silicon, and silica aerogel is an aerogel which comprises silicon-oxygen bonds (siloxane bridges) as the basis of its framework. Silica aerogel may be modified or unmodified. Modified silica aerogels are functionalized with SiR₃ groups described elsewhere in the literature. In the present invention, a method to impart the functionalized groups have been described in some of the embodiments.

The term “silica aerogel composite” refers to a silica aerogel which in addition to the silica framework, comprises at least another part, element, substance, salt, molecule or compound. Such elements can be either of an organic or inorganic nature, can interact in a physical or chemical manner, or not interact with the silica framework. Silica aerogel composites can have physical or chemical characteristics that are substantially similar or different from its individual elements. Silica aerogel composites may exhibit an improvement of an individual property or collective improvements of several properties. For example, if thermal insulation and strength are the desired characteristics of the aerogel composite, an aerogel composite may be incorporated with fillers, fibers to reduce the brittleness of the aerogel and at the same time retain substantially similar or improve the thermal insulation properties as the aerogel.

As used herein, “polysaccharide aerogel” refers to an aerogel which has cellulosic content as a base component. “Cellulose” as used herein, refers to a polymer made of repeating glucose molecules attached end to end, and can be of any size and dimension. Cellulose is a linear polysaccharide comprising β(1-4)-D-glucopyranose units in ⁴C₁ conformation. The conformation of β-linked glucopyranose residues stabilizes the chair structure. Cellulose is an insoluble polymer in water and may exist in four crystalline forms: I_{α}, I_{β}, II and III. As used herein, the term “cellulose” also encompasses within its scope natural cellulose fibers and manufactured cellulose fibers. The cellulose would also include recycled cellulose made from waste paper, cardboards and tissues. Derivates of cellulose such as esters of cellulose, ethers of cellulose and nitrate cellulose form the most important cellulose structure in commercial application. Another group of polysaccharides are the chitosan and chitin that can form nanostructure network when synthesised under the right conditions.

As used herein, “polymer aerogel” refers to an aerogel which has at least one polymeric material as a base component. Specially, biodegradable polymer aerogel is of interest. Biodegradable polymers can be classified as natural and synthetic. Natural biodegradable polymers include biopolymers extracted from biomass such as polysaccharides, polypeptides and lipids and biopolymers from microorganisms such as microbial polyesters, bacterial cellulose and polymers synthesized from bio-derived monomers. Aliphatic polyesters and polyvinyl alcohol and polyvinyl acetate fall under synthetic biodegradable polymers.

Various embodiments of the present invention refer to a method of manufacturing a water based hydrophobic aerogel and aerogel composite (collectively termed as “aerogel”. The term “manufacture”, “manufacturing” refers to the make (or making) of something on a large scale. This can be either by manual labour or by machinery or by both. Thus, in a manufacturing sense and in the context of the present invention, an aerogel or aerogel composite of at least about 150 mm by about 150 mm is desired. Preferably, an aerogel or aerogel composite of about 250 mm by 250 mm is desired. Preferably, an aerogel or aerogel composite of about 300 mm by 300 mm is desired. Preferably, an aerogel or aerogel composite of about 500 mm by 500 mm, or about 600 mm by about 1200 mm is desired. Preferably, an aerogel or aerogel composite of about 700mm by 1400 mm is desired. Even more preferably, an aerogel or aerogel composite of about 1200 mm by about 2400 mm is desired. The thickness of the mentioned an aerogel or aerogel composite may be in the range of about 5 mm to about 100 mm.

The water-based binder and surfactant may be added at the same time or in a sequential manner to the aqueous mixture (110). For example, the water-based binder may be added first, followed by the surfactant. Alternatively, the surfactant may be added first, followed by the binder. The water-based binder may be partially, substantially or completely dissolved in the aqueous mixture before the surfactant is added.

Alternatively, the surfactant may be partially, substantially or completely dissolved in the aqueous mixture before the water-based binder is added.

In some embodiments, the step of providing the aqueous mixture comprises a mixing step and an agitation step. In the mixing step, the materials or elements are combined or put together in the aqueous mixture. The mixing step can be, but not limited to, stirring, beating, blending, creaming, whipping, folding, homogenising or sonicating. The energy required to combine the elements into the aqueous mixture depends on the solubility of the elements and their interaction.

In some embodiments, the step of providing the aqueous mixture comprises a mixing step, wherein sonication is used in the mixing step.

In some embodiments, after the mixing step, the aqueous mixture undergoes high speed mixing in the agitation step. It is desirable that the speed at which the mixer blades be controlled so as to produce a froth with consistent air bubbles sizes. It is also desirable that the air pockets generated in the foam is stabilized and that the pressure within the foam does not collapse rapidly. As such, it is desirable that the speed of agitation be maintained to be greater than about 1500 rpm but lesser than 5000 rpm.

In some embodiments, the step of providing the aqueous mixture comprises a mixing step and an agitation step, wherein the agitation step comprises homogenising the aqueous mixture. The mixing step ensures that the water-based binder and the surfactant are uniformly dispersed in the aqueous mixture. In this sense, the surfactant may help in the dispersion of the water-based binder. As such, the water-based binder may be partially, substantially or completed dissolved in the aqueous mixture. The agitation step introduces air bubbles into the aqueous mixture, and foams the aqueous mixture. Homogenization, due to its shearing action on the liquid, may advantageously increase the volume of mixture up to about 300% as a result of the air pockets formed. This allows for easier mixing of the silyl-modified precursors in the subsequent process.

In some embodiments, the step of providing the aqueous mixture comprises a mixing step, an agitation step under vacuum, wherein the agitation step comprises homogenising the aqueous solution under vacuum. The mixing step ensures that the water-based binder and the surfactant are uniformly dispersed in the aqueous mixture. In this sense, the surfactant may help in the dispersion of the water-based binder.

As such, the water-based binder may be partially, substantially or completed dissolved in the aqueous mixture. The agitation step under vacuum stabilises the emulsion resulting by removing excess and trapped air bubbles from the mixture and aqueous mixture. Homogenization, due to its shearing action on the liquid, may advantageously increase the volume of mixture up to about 100% as a result of the excess air removed to promote compaction of solid in liquid suspension. This allows for easier mixing of the silyl-modified precursors in the subsequent process.

Accordingly, in some embodiments, the step of providing the aqueous mixture comprising a mixing and agitation step under vacuum, wherein the mixing step comprises sonication and agitation step comprises homogenization either in a vacuum pot or otherwise.

Another aspect of the invention involves the vacuum mixing of the aqueous solution of binder and additives.

The mixing of emulsion under vacuum conditions ensures high compaction of particles under mixture, hastens the crosslinking process and homogeneity in emulsion without phase separation. Phase separation of solid and liquid in suspension often affect the final properties and causes inconsistency in results. The vacuum mixing and agitation can be accomplished in a one pot or two pot synthesis.

The aqueous mixture comprising the mixing and agitation step can be performed at any workable temperature. For example, while the aqueous mixture is most often formed mixed and agitated at an ambient temperature, it is appreciated that any temperature would work as long as the aqueous mixture does not totally solidify into ice or completely evaporate as a gas. Additionally, to assist in the mixing and agitation, the temperature may be varied.

In some embodiments, the aqueous mixture further comprises fire retardants, inorganic fillers, and a strengthening agent. Strengthening agent is an additive which may improve the mechanical property of a material. The strengthening agent may be selected from a group comprising, but not limited to, fumed silica, mineral fiber, calcium silicate, basalt fibers, basalt powders, silica fibers, ceramic fibers, polymeric fibers, glass fibers or a combination thereof. In some embodiments, the strengthening agent is fumed silica. In some embodiments, the strengthening agent is mineral fiber. In some embodiments, the strengthening agent is calcium silicate. In some embodiments, the strengthening agent is basalt fibers. In some embodiments, the strengthening agent is silica fibers. In an embodiment, strengthening agent is a combination of fumed silica, silica fibers and basalt fibers. In an embodiment, the strengthening agent is a combination of mineral fiber, calcium silicate and silica fiber.

Inorganic filler is an additive to enhance the property of a material. The addition of inorganic filler may enhance the fire resistance, fire retardant properties and/or insulation properties of the water based hydrophobic aerogels. The inorganic filler may be selected from a group comprising of, but not limited to, amorphous silica, ceramics, quartz, zirconium dioxide, silicon carbide, graphite, iron (III) oxide, titanium oxide, barium sulphate, zinc borate, graphite, graphene, sodium decahydrate tetraborate, boric acid or a combination thereof. Inorganic fillers may be used to improve or impart fire resistant property to the water based hydrophobic aerogel. Examples of fire resistant inorganic fillers are, but not limited to, ceramics, zirconium dioxide, iron (III) oxide, titanium oxide, fumed silica and borates of various types, for example zinc and sodium. Inorganic fillers may be used to improve or impart fire retardant property to the water based hydrophobic aerogels. Examples of fire retardant inorganic fillers are, but not limited to, zirconia fibers, ceramic fibers and mineral fibers. In some embodiments, the inorganic filler is titanium oxide. In some embodiments, the inorganic filler is barium sulphate. In some embodiments, the inorganic filler is zinc borate. In some embodiments, the inorganic filler is boric acid. In some embodiments, the inorganic filler is zirconium dioxide. In an embodiment, the inorganic filler is a combination of titanium oxide, zinc borate amorphous silica.

As mentioned above, the water-based binder may be used to hold or draw materials together. The water-based binder may include at least one of —OH, —COON or —NH₂ functional groups along the chain of the molecular structure. The water-based binder may be selected from a group comprising of, but not limited to, gelatin, polyacrylamide, polyvinyl pyrrolidone, polymethacrylamide, polyvinyl alcohol, or a combination thereof. Other water-based inorganic binders would include sodium silicate, silicone based binders, boron silicates, sodium phosphates. Other water soluble self crosslinking binders in the form of silicone, acrylic, polyurethane, phenolic or co-polymer blocks in combination of acrylic, silicone, siloxane, phenolic and polyurethane are also considered.

In some embodiments, the water-based binder is gelatin. In some embodiments, the polymeric binder is polyvinyl alcohol. Advantageously, polyvinyl alcohol is a slow synthetic biodegradable polymer, and is non-toxic and non-hazardous. It is soluble in water and foams well. It is also versatile enough to be synthesized as polymer blends. Polyvinyl alcohol has excellent film forming, emulsifying and adhesive properties.

In some embodiments, the water-based binder is a self-crosslinking type which accelerates crosslinking at elevated temperatures during vacuum mixing. Commercially available products of such chemistry are wide and diverse and have been shown to produce equally strong and lightweight aerogel composites. Advantageously, the self-crosslinking binder does not need for further crosslinking agents. Advantageously, gelation of these binders can be achieved by controlling the temperature and the pH levels.

The surfactant is added to improve wettability of the emulsion and lower the surface tension of the aqueous mixture. In some embodiments, the surfactant is sodium dodecyl sulfate. In some embodiments the surfactant is quaternary ammonium salts. In some embodiments, the surfactant is alcohol ethoxylates. In some embodiments the surfactant is cetyl trimethylammonium bromide.

Without the need to be bound by theory, silyl modified precursors can be prepared via several methods such as sol-gel techniques, emulsion techniques, phase transfer techniques and obtaining such precursors from commercial means (120). For example, it may be possible to start from a commercially available silica aerogel in a granule, particle, needle, powder or micronized form. Accordingly, it may be possible to choose to start from commercially available cellulose fibrous material as precursor. Such cellulose material may be in fiber, particle, needle, powder, nanosized or micronized form. The commercially bought ones may need to undergo partial or full wetting by using surfactants to facilitate interactions between hydrophilic and hydrophobic groups during the emulsion stage. Other methods of obtaining silyl-modified precursors would include via sol-gel techniques and phase transfer techniques which have been widely published in journals and literature. The precursors could be silanes, cellulosic, polymeric or combination of thereof.

The silyl-modified precursor may include one or more —SiR functional groups as defined herein. For example, the silyl-modified precursor may include one or more of —Si(CH₃), —Si(C₂H₅), —Si(C₃H₇), to name only a few. In various embodiments, R is methyl, methoxy or ethoxy. For example, the silyl-modified precursor may contain Si(CH₃) or Si(OC₂H₅) terminal groups. In other examples, the silyl-modified precursor is modified to contain one or more —SiR groups, wherein R is selected from optionally substituted C₁-C₆ alkyl. Such methods are known in the art and will not be herein described.

Chemical crosslinking may be used to promote the formation of a three-dimensional network of turning silyl-modified precursor emulsion under vacuum homogenization into gelled composites (130). For example, carbonyls groups may be used to react with hydrazide, hydroxyl, amine groups or other functional groups.

The rate of crosslinking is dependent on the reactivity of the groups and the temperature of the solution, among other parameters. Thus, careful control of these parameters is essential to allow for ease of handling and processing of the water based hydrophobic aerogel. For example, at a temperature of 25° C., addition of about 0.5% to 5.0 wt % (final composite weight) of crosslinking agent would provide sufficient time for mixing and laying the mixture into a mold without the mixture solidifying too quickly. Accordingly, in some embodiments, the crosslinking process is initiated upon addition of the crosslinking agent. In another embodiment, the crosslinking process is initiated after all the crosslinking agents are added but before the MAVFD step. In another embodiment, the crosslinking process is initiated some time during the addition of the crosslinking agent. In another embodiment, the crosslinking process is initiated some time after the addition of the crosslinking agent. Preferably, the crosslinking process is initiated later in the manufacturing process, after formation of the gelled composite but before MAVFD. The crosslinking agent may be selected from a group comprising, but not limited to, polyfunctional aziridines, carbodiimides, polyisocyanates, blocked isocyanates, melamine-formaldehyde, oxiranes, polyalcohols, aldehydes, glycidyl ethers, glycidyl esters, carboxyl compounds, amines, epoxides, vinyl sulfones, amides, allyl compounds, or combinations thereof.

In most embodiments, the method of manufacturing water based hydrophobic aerogel further comprises in-situ treatment of gelled composites of hydrophobic agents while in mixing in vacuum conditions to wherein the gelled composite emulsion is reacted with a hydrophobic material during in-situ mixing under vacuum conditions (140).

Thus a water based hydrogel infused with hydrophobic agents will produce a hydrophobic aerogel upon microwave assisted vacuum freeze drying and rapid curing. If a hydrophobic aerogel is desired, an infused step may be performed. The infused step is performed by adding a water based hydrophobic material, for example a water based siloxane coupling agent. The water based siloxane coupling agent will react with the remaining hydrophilic functional groups in the gelled composite and render them hydrophobic, and thus turn the final aerogel hydrophobic. Specifically, the infusion process involves time controlled mixing under vacuum under elevated temperature heating the siloxane coupling agent allowing the silanes to diffuse into the emulsion mixture and react with the hydrophilic functional groups of the gelled composite to form the hydrophobic groups. In the process, the disposed hydrophilic groups may further react with siloxane coupling agents to form additional hydrophobic layers. The duration and temperature of coating depends on the desired degree of hydrophobicity and the type of siloxane used. In some embodiments, the duration of the infusion step is about 1 h, about 1.5 h, about 2 h, about 2.5 h, about 3 h, about 3.5 h, about 4 h, about 4.5 h, about 5 h, about 6 h, about 8 h, about 10 h, about 12 h, or about 24 h. In some embodiments, the temperature of the infusion step is about 40° C., about 45° C., about 50° C., about 55° C., about 60° C., about 65° C., about 70° C., about 75° C., about 80° C., about 85° C., about 90° C., about 95° C., or about 100° C.

The in-situ hydrophobic treatment imparts a hydrophobic nature to the water based gelled composite, thus giving the aerogel composite a better shelf-life. This is especially so in a high humidity environment. The hydrophobic treatment done in this way may also further enhance the water repellency or water resistance of the water based aerogel. Accordingly, the degree of infusion can be controlled by varying the amount of hydrophobic material used. The degree of infusion can be tested using a water sorption test or measuring the contact angles of a water/oil droplet.

The hydrophobic material can be any hydrophobic material that interacts with water based aerogels. Such interaction may be chemical or physical. For example, silane and siloxane coupling agents may be used. Examples of silane and siloxane coupling agents are, but not limited to, methyltrichlorosilane, methyltrimethoxysilane, methyltriethoxysilane, trimethylsiloxytrichlorosilane, dimethyltetramethoxydisiloxane, dimethyldichlorosilane, trimethylchlorosilane, dimethyldimethoxysilane, trimethylmethoxysilane, dimethyldiethoxysilane, trimethylethoxysilane, trimethyl-n-propoxysilane, methoxypropoxytrimethylsilane, dimethyldiacetwrysilane, acetoxytrimethylsilane, bis(dimethylamino)dimethylsilane, dimethylaminotrimethylsilane, bis(diethylamino)dimethylsilane, hexamethylcyclotrisilazane, hexamethyldisilazane, dichlorotetramethyldisiloxane, dichlorohexamethyltrisiloxane, chlorine terminated polydimethylsiloxane, methoxy terminated polydimethylsiloxane, ethoxy terminated polydimethylsiloxane, dimethylamine terminated polydimethylsiloxane, silanol terminated polydimethylsiloxane, dimethylethoxysilane, ethyltriethoxysilane, ethyltriacetoxysilane, propyltrichlorosilane, propyltrimethoxysilane, propyltriethoxysilane, n-butyltrichlorosilane, n-butyltrimethoxysilane, pentyltrichlorosilane, pentyltriethoxysilane, hexyltrichlorosilane, hexyltrimethoxysilane, hexyltriethoxysilane, heptyltrichlorosilane, octyltrichlorosilane, octyltrimethoxysilane, octyltriethoxysilane, decyltrichlorosilane, decyltriethoxysilane, undecyltrichlorosilane, dodecyltrichlorosilane, dodecyltriethoxysilane, tetradecyltrichlorosilane, hexadecyltrichlorosilane, hexadecyltrimethoxysilane, hexadecyltriethoxysilane, octadecyltrichlorosilane, octadecyltrimethoxysilane, octadecyltriethoxysilane, eicosyltrichlorosilane, docosyltrichlorosilane, triacontyltrichlorosilane, ethylmethyldichlorosilane, ethyldimethylchlorosilane, propylmethyldichlorosilane, propyldimethylchlorosilane, propylmethyldimethoxysilane, propyldimethylmethoxysilane, dipropyltetramethyldisilazane, hexylmethyldichlorosilane, heptylmethyldichlorosilane, octylmethyldichlorosilane, octyldimethylchlorosilane, octyldimethylmethwrysilane, octylmethyldiethoxysilane, dioctyltetramethyldisilazane, decylmethyldichlorosilane, decyldimethylchlorosilane, dodecylmethyldichlorosilane, dodecyldimethylchlorosilane, dodecylmethyldiethoxysilane, octadecylmethyldichlorosilane, octadecyldimethylchlorosilane, octadecylmethyldimethoxysilane, octadecyldimethylmethoxysilane, octadecylmethyldiethoxysilane, octadecyldimethyl(dimethylamino)silane, docosylmethyldichlorosilane, triacontyldimethylchlorosilane, isobutyltrichlorosilane, isobutyltrimethoxysilane, isobutyltriethoxysilane, t-butyltrichlorosilane, cyclopentyltrichlorosilane, cyclopentyltrimethoxysilane, thexyltrichlorosilane, cyclohexyltrichlorosilane, cyclohexyltrimethoxysilane, bicycloheptyltrichlorosilane, (cyclohexylmethyl)trichlorosilane, isooctyltrichlorosilane, isooctyltrimethoxysilane, cyclooctyltrichlorosilane, adamantylethyltrichlorosilane, 7-(trichlorosilylmethyl)pentadecane, (di-n-octylmethylsilyl)ethyltrichlorosilane, isopropylmethyldichlorosilane, isopropyldimethylchlorosilane, isobutyldimethylchlorosilane, isobutylmethyldimethoxysilane, t-butylmethyldichlorosilane, t-butyldimethylchlorosilane, cyclohexyldimethylchlorosilane, isooctyldimethylchlorosilane, (dimethylchlorosilyl)methylpinane, benzyltrichlorosilane, benzyltriethoxysilane, 1-phenyl-1-trichlorosilylbutane, phenethyltrichlorosilane, phenethyltrimethoxysilane, 4-phenylbutyltrichlorosilane, phenoxypropyltrichlorosilane, phenoxyundecyltrichlorosilane, phenylhexyltrichlorosilane, p-tolyltrichlorosilane, p-tolyltrimethoxysilane, ethylphenethyltrimethoxysilane, p-(t-butyl)phenethyltrichlorosilane, phenylmethyldichlorosilane, phenyldimethylchlorosilane, phenylmethyldimethoxysilane, phenylmethyldiethoxysilane, phenyldimethylethoxysilane, phenylmethylbis(dimethylamino)silane, benzyldimethylchlorosilane, 1-phenyl-1-methyldichlorosilylbutane, phenethylmethyldichlorosilane, phenethyldimethylchlorosilane, phenethyldimethyl(dimethylamino)silane, (3-phenylpropyl)methyldichlorosilane, (3-phenylpropyl)dimethylchlorosilane, 4-phenylbutylmethyldichlorosilane, 4-phenylbutyldimethylchlorosilane, phenoxypropylmethyldichlorosilane, phenoxypropyldimethylchlorosilane, p-tolylmethydichlorosilane, p-tolyldimethylchlorosilane, m-phenoxyphenyldimethylchlorosilane, p-nonylphenoxypropyldimethylchlorosilane, nonafluorohexyltrichlorosilane, nonafluorohexyltrimethoxysilane, nonafluorohexyltriethoxysilane, diethyldichlorosilane, diethyldiethoxysilane, diisopropyldichlorosilane, diisopropyldimethoxysilane, di-n-butyldichlorosilane, di-n-butyldimethoxysilane, diisobutyldimethoxysilane, diisobutyldiethoxysilane, isobutylisopropyldimethoxysilane, dicyclopentyldichlorosilane, dicyclopentyldimethoxysilane, di-n-hexyldichlorosilane, dicyclohexyldichlorosilane, di-n-octyldichlorosilane, ethoxytrimethylsilane, or the like.

In some embodiments, the hydrophobic material is methyltrimethoxysilane. In some embodiments, the hydrophobic material is propyltrimethoxysilane. In some embodiments, the hydrophobic material is tetraethoxysilane. In some embodiments, the hydrophobic material is n-Octyltriethoxysilane. In some embodiments, the hydrophobic material is hexamethyldisilazane. In an embodiment, the hydrophobic material is a mixture of silane coupling agents, for example n-Octyltriethoxysilane and tetraethoxysilane.

In most embodiments, the hydrophobized gelled composite is shaped in a mold before freezing. The mold may be of any desired shape or size. Individual molds may be used to cast water based hydrophobic aerogel composites as panels. Alternatively, a mold may be used to cast the water based hydrophobic aerogel which is then subsequently cut into a desired shape and size. For example, the mold may be in one dimension about 150 mm, about 200 mm, about 250 mm, about 300 mm, about 350 mm, about 400 mm, about 450 mm, about 500 mm, about 600 mm, about 700 mm, about 800 mm, about 900 mm, about 1000 mm, about 1200 mm, about 1400 mm, about 1600 mm, about 1800 mm, about 2000 mm, about 2500 mm, about 3000 mm, about 4000 mm, about 5000 mm, about 7500 mm or about 10000 mm. In an embodiment, the size of the mold is about 800 mm by about 1200 mm.

In most embodiments, the hydrophobized gelled composite in molds will undergo deep freezing (150). The predetermined temperature may be about −120° C., about −110° C., about −100° C., about −90° C., about −80° C., about −70° C., about −60° C., about −50° C. and about −40° C. to ensure good frozen state of gelled composite. In some embodiments freezing is accomplished through deep freezing chambers using CO2. In some embodiments freezing is accomplished via flash freezing using LN2. In some embodiments freezing is accomplished via commercially available ultra low temperature deep freezers.

In all embodiments, the frozen gelled composite will undergo microwave assisted freeze drying (MAVFD) to obtain aerogel and/or aerogel composites (160). Microwaves are electromagnetic waves within a frequency band of 300 MHz to 300 GHz embedded between radio and IR/visible light frequencies. Microwaves belong to the non-ionising radiation that are typically found in many household applications.

For industrial, scientific and medical applications (called ISM-Frequencies), only frequencies of 915MHz and 2450 MHz are being used.

A key principle in MAVFD technology is the very low dielectric losses of frozen water in conditions below −10° C. Therefore, the energy will mainly be absorbed by the molecules of the gelled composite or aerogel.

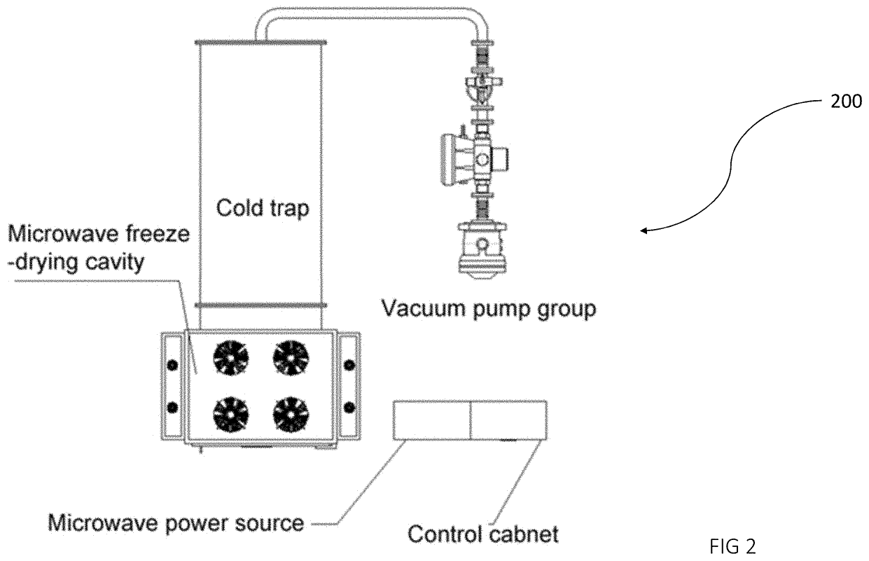

The dielectric losses of frozen water is negligible or transparent during the initial phase of MAVFD when the penetration depth is significant and the energy can be transferred due to the dielectric losses of the aerogel contributing to higher efficiency and faster drying of gelled composites into aerogel. This allows rapid dissipation of energy throughout the frozen gelled aerogels. The whole process proceeds under a vacuum environment of 0.5 to 2.5 mbar by sublimation. Furthermore, compared to a conventional freeze drying system which transfers heat from the outside for layer after layer drying mechanism, the MAVFD system generates heat within the gelled composite or aerogel itself so that sublimation is taking place within the complete product volume. Additionally, MAVFD unlocks the limitation of transferring heat when frozen water is sublimated within the aerogel pores where the volume could be in micrometer to nanometer range. The penetration depth can be up to 20 to 40 cm of aerogel volume, which gives a clear advantage over other types of aerogel where thickness of aerogel products are limited by thickness. Another advantage is the final moisture content can be as low as 0.5% unlike in conventional freeze drying methods where final moisture content is likely to be above 10% requiring additional post processes to reduce the final moisture content. Unlike conventional freeze drying, there is no need for a secondary freeze drying step in microwave assisted vacuum freeze drying. Advantageously, this reduces the drying time to 1/10 and 1/20 of that of convectional freeze drying method. FIG. 2 shows a schematic view of a microwave assisted vacuum freeze dryer (200).

The pre-determined pressure and cold trap temperature is thus carefully chosen, not only to allow for the sublimation of ice to gas, but also to ensure a good end product with good consistency.

In some embodiments, the pre-determined cold trap temperature is lower than about −5° C., about −10° C., about −15° C., about −20° C., about −25° C., about −30° C., about −35° C., about −40° C., about −45° C., about −50° C. or about −60° C.

In some embodiments, the pre-determined pressure is in a range of about 20 Pa to about 400 Pa.

In most embodiments, the microwave frequency is 2450 MHz. In some embodiments, the microwave frequency is 915 MHz.

In most embodiments, the microwave assisted vacuum freeze drying is by pulsating mode. In some embodiments, the microwave assisted vacuum freeze drying is by continuous mode. In some embodiments, the microwave assisted vacuum freeze drying is by discontinuous mode. In some embodiments, the microwave assisted vacuum freeze drying is by a combination of the above.

The input energy of the microwave assisted vacuum freeze drying depends on weight of the frozen gelled composites and the amount of aqueous content. In some embodiments, the input energy of the microwave assisted vacuum freeze drying is about 2.0 KW per 100 gram gel, about 1.9 KW per 100 gram gel, about 1.8 KW per 100 gram gel, about 1.7 KW per 100 gram gel, about 1.6 KW per 100 gram gel, about 1.5 KW per 100 gram gel, about 1.4 KW per 100 gram gel, about 1.3 KW per 100 gram gel, about 1.2 KW per 100 gram gel, about 1.1 KW per 100 gram gel, about 1.0 KW per 100 gram gel, about 0.9 KW per 100 gram gel, about 0.8 KW per 100 gram gel, about 0.7 KW per 100 gram gel, about 0.6 KW per 100 gram gel, about 0.5 KW per 100 gram gel, about 0.4 KW per 100 gram gel, about 0.3 KW per 100 gram gel, about 0.2 KW per 100 gram gel, about 0.1 KW per 100 gram, or about 0.05 KW per 100 gram.

In some embodiments, the duration of the microwave assisted vacuum freeze drying is about 1 h, about 1.5 h, about 2 h, about 2.5 h, about 3 h, about 3.5 h, about 4 h, about 4.5 h, about 5 h, about 6 h, about 8 h, about 10 h, about 12 h, about 14 h, about 16 h, about 18 h, about 20 h, about 22 h, or about 24 h.

It is also found that a curing step (170) can advantageously ensure that the water based hydrophobic aerogel is substantially or completely dehydrated. This ensures that the final product's strength and stability is not compromised. Additionally, the curing step also acts to ensure that the crosslinking agent is substantially or completely reacted with the elements.

The temperature and duration of the cure depends on the type and amount of crosslinking agent used, as well as the size and thickness of the silica aerogel composite. In some embodiments, the temperature of the cure is about 40° C., about 45° C., about 50° C., about 55° C., about 60° C., about 65° C., about 70° C., about 75° C., about 80° C., about 85° C., about 90° C., about 95° C., or about 100° C., about 110° C. , about 120° C., about 130° C., about 140° C., or about 150° C. In some embodiments, the duration of the cure is about 1 h, about 1.5 h, about 2 h, about 2.5 h, about 3 h, about 3.5 h, about 4 h, about 4.5 h, about 5 h, about 6 h, about 8 h, about 10 h, about 12 h, or about 24 h.

Alternatively, the coating may be a coating which adheres to the surface of the aerogel composite by physical interactions. For example, the coating may be spray painted or brush painted onto the surface of the aerogel composite with lacquer, varnish, oil, wax, or the likes. Such methods of coatings are known in the art and accordingly is not limited to the disclosure herein.

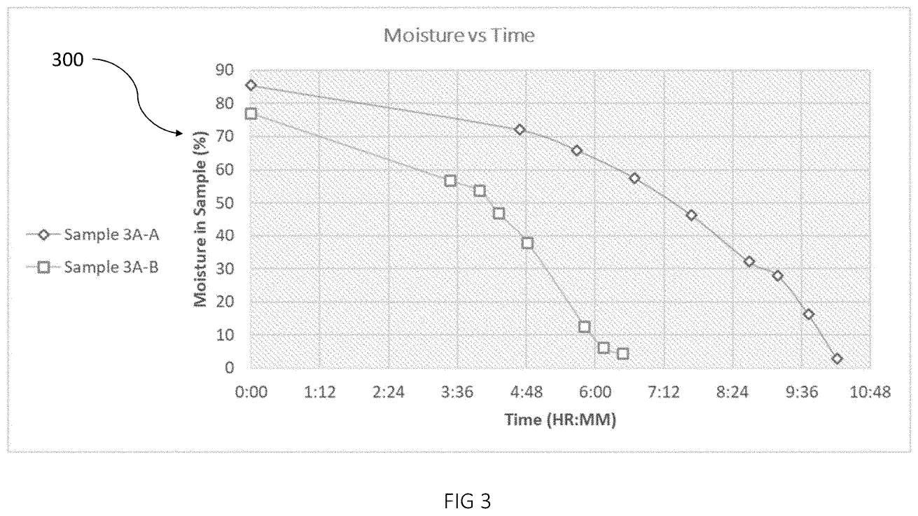

After the microwave assisted vacuum freeze drying is completed and all ice has sublimed, the inventors have found that bound moisture is still present in the water based hydrophobic aerogel and aerogel composite is lower than conventional freeze drying method. It was found that the residual moisture content may be as low as 0.5 %. Typically, the moisture content is between 0.5% and 5.0%. FIG. 3 shows the moisture content of a typical drying profile as a function of time (300)

The amount of water-based binder may be added in a range of about 2 wt % to about 40 wt % of the final composite weight. For example, the amount of water-based binder may be in a range of about 2 wt % to about 35 wt %, about 5 wt % to about 30 wt %, or about 10 wt % to about 20 wt %.

The amount of surfactant may be added in a range of about 0.1 wt % to about 2 wt % of the final composite weight. For example, the amount of surfactant may be in a range of about 0.1 wt % to about 1.9 wt %, about 0.1 wt % to about 1.8 wt %, about 0.1 wt % to about 1.7 wt %, about 0.1 wt % to about 1.6 wt %, about 0.1 wt % to about 1.5 wt %, about 0.1 wt % to about 1.4 wt %, about 0.1 wt % to about 1.3 wt %, about 0.1 wt % to about 1.2 wt %, about 0.1 wt % to about 1.1 wt %, or about 0.1 wt % to about 1.0 wt % .

The amount of silyl modified precursors may be added in a range of about 10 wt % to about 90 wt % of the final composite weight. For example, the amount of silyl modified precursors may be in a range of about 15 wt % to about 90 wt %, about 20 wt % to about 90 wt %, about 25 wt % to about 90 wt %, about 30 wt % to about 80 wt %, about 40 wt % to about 80 wt %, about 50 wt % to about 80 wt %, about 60 wt % to about 80 wt %, about 70 wt % to about 80 wt %, or about 70 wt % to about 90 wt %.

The amount of crosslinking agent may be added in a range of about 0.5 wt % to about 10 wt % of the final composite weight. For example, the amount of crosslinking agent may be in a range of about 0.5 wt % to about 9 wt %, 0.5 wt % to about 8 wt %, 0.5 wt % to about 7 wt %, 0.5 wt % to about 6 wt %, 0.5 wt % to about 5 wt %, 1 wt % to about 5 wt %, 1.5 wt % to about 5 wt %, 2 wt % to about 5 wt %, 2.5 wt % to about 5 wt %, 3 wt % to about 5 wt %, or 3.5 wt % to about 5 wt %. The amount of crosslinking agent may be added at about 0.5 wt %, about 1.0 wt %, about 1.5 wt %, about 1.8 wt %, about 2.0 wt %, about 2.5 wt %, about 3.0 wt %, about 3.5 wt %, about 4.0 wt %, about 4.5 wt % or about 5.0 wt %.

The amount of fire retardants may be added in a range of about 0.1 wt % to about 10 wt % of the final composite weight. For example, the fire retardants may be in a range of about 0.1 wt % to about 10 wt %, 0.5 wt % to about 10 wt %, 1 wt % to about 10 wt %, 1.5 wt % to about 10 wt %, 2 wt % to about 10 wt %, 2.5 wt % to about 10 wt %, 3 wt % to about 10 wt %, 3.5 wt % to about 10 wt %, 4 wt % to about 10 wt %, 5 wt % to about 10 wt %, 6 wt % to about 10 wt %, 6 wt % to about 9.5 wt %, or 6 wt % to about 9 wt %.

The amount of inorganic filler may be added in a range of about 0.1 wt % to about 10 wt % of the final composite weight. For example, the inorganic filler may be in a range of about 0.1 wt % to about 10 wt %, 0.5 wt % to about 10 wt %, 1 wt % to about 10 wt %, 1.5 wt % to about 10 wt %, 2 wt % to about 10 wt %, 2.5 wt % to about 10 wt %, 3 wt % to about 10 wt %, 3.5 wt % to about 10 wt %, 4 wt % to about 10 wt %, 5 wt % to about 10 wt %, 6 wt % to about 10 wt %, 6 wt % to about 9.5 wt %, or 6 wt % to about 9 wt %.

The amount of strengthening agent may be added in a range of about 10 wt % to about 70 wt % of the final composite weight. For example, the strengthening agent may be in a range of about 10 wt % to about 60 wt %, about 10 wt % to about 50 wt %, about 10 wt % to about 40 wt %, about 10 wt % to about 30 wt %, about 20 wt % to about 60 wt %, about 20 wt % to about 50 wt %, or about 20 wt % to about 40 wt %.

The amount of solvent component in the aqueous mixture may be in a range of about 100 wt % to about 700 wt % of the final composite weight. For example, the solvent component may be in a range of about 100 wt % to about 650 wt %, about 100 wt % to about 600 wt %, about 100 wt % to about 550 wt %, about 150 wt % to about 550 wt %, about 200 wt % to about 550 wt %, about 200 wt % to about 500 wt %, about 200 wt % to about 450 wt %, about 200 wt % to about 400 wt %, about 200 wt % to about 350 wt %, or about 200 wt % to about 300 wt %.

In another aspect, the present invention discloses a water based hydrophobic silica aerogel manufactured by a method as herein described. The method comprises firstly providing an aqueous mixture which comprises a water-based binder, fillers, fire retardant and a surfactant. A silyl-modified precursor comprising a silica system is added to the aqueous mixture to form an emulsion, after which a water soluble crosslinking agent is added to produce a gelled composite and in-situ water-based hydrophobic agent is added to the gelled composite under vacuum homogenizing and mixing conditions. The hydrophobized gelled composite is frozen and the frozen gelled composite is microwave assisted vacuum freeze dried at a pre-determined pressure and at a pre-determined temperature by inducing microwave rapid bulk heating throughout the gelled composite affected in the presence of vacuum sufficient for sublimation of ice to form a aerogel and then cured to form the hydrophobic silica aerogels and silica aerogel composites.

Advantageously, the water based hydrophobic silica aerogel can be produced at least on a large scale of about 800 mm by 1200 mm with a thickness of about 5 mm to about 100 mm and with good homogeneity and consistency, i.e. homogeneous distribution of all components throughout its cross-section. Advantageously, the water based hydrophobic aerogel can be produced on a large scale continuous process with a width of 500 mm to 1000 mm with a thickness of about 5 mm to about 100 mm and with good homogeneity and consistency.

The water based hydrophobic silica aerogel may further comprise a strengthening agent. The strengthening agent may be added in the aqueous mixture with the water-based binder and surfactant. This aqueous mixture is mixed and processed similarly as mentioned above to give the water based hydrophobic silica aerogel.

The water based hydrophobic silica aerogel may have a thermal conductivity in a range of about 0.010 W/mK to about 0.038 W/mK. For example, the water based hydrophobic silica aerogel may have a thermal conductivity of about 0.010 W/mK to about 0.038 W/mK, about 0.010 W/mK to about 0.035 W/mK, about 0.010 W/mK to about 0.030 W/mK, about 0.010 W/mK to about 0.024 W/mK, about 0.010 W/mK to about 0.022 W/mK, about 0.010 W/mK to about 0.020 W/mK, about 0.012 W/mK to about 0.026 W/mK, about 0.014 W/mK to about 0.026 W/mK, about 0.016 W/mK to about 0.026 W/mK, about 0.018 W/mK to about 0.026 W/mK, about 0.018 W/mK to about 0.024 W/mK, or about 0.019 W/mK to about 0.023 W/mK.

The water based hydrophobic silica aerogel may have a density in a range of about 0.04 g/cm³ to about 0.17 g/cm³. For example, the water based hydrophobic silica aerogel may have a density of about 0.04 g/cm³ to about 0.16 g/cm³, about 0.05 g/cm³ to about 0.15 g/cm³, about 0.06 g/cm³ to about 0.145 g/cm³, about 0.07 g/cm³ to about 0.14 g/cm³, about 0.07 g/cm³ to about 0.135 g/cm³, about 0.07 g/cm³ to about 0.13 g/cm³, about 0.07 g/cm³ to about 0.125 g/cm³, about 0.07 g/cm³ to about 0.12 g/cm³, about 0.07 g/cm³ to about 0.115 g/cm³, or about 0.075 g/cm³ to about 0.12 g/cm³.

The water based hydrophobic silica aerogel may have a compressive modulus in a range of about 0.5 MPa to about 40 MPa. For example, the water based hydrophobic silica aerogel may have a compressive modulus in a range of about 1 MPa to about 40 MPa, about 3 MPa to about 40 MPa, about 5 MPa to about 35 MPa, about 10 MPa to about 30 MPa, or about 15 MPa to about 25 MPa.

The water based hydrophobic silica aerogel may have a compressive strength in a range of about 0.1 MPa to about 4.5 MPa. For example, the water based hydrophobic silica aerogel may have a compressive strength at least about 0.1 MPa, about 0.2 MPa, about 0.6 MPa, about 1.5 MPa, about 2.0 MPa, about 3.0 MPa, about 3.5 MPa, about 3.8 MPa, about 4.0 MPa, or about 4.5 MPa.

The water based hydrophobic silica aerogel may have a specific surface area in a range of about 5 m²/g to about 300m²/g. For example, the water based hydrophobic aerogel may have a specific surface area in a range of about 5 m²/g to about 300m²/g, about 10 m²/g to about 300 m²/g, about 15 m²/g to about 300m²/g, about 20 m²/g to about 300m²/g, about 25 m²/g to about 300m²/g, about 30 m²/g to about 300m²/g, about 35 m²/g to about 300m²/g, about 40 m²/g to about 300m²/g, about 45 m²/g to about 250m²/g, about 50 m²/g to about 200 m²/g, about 55 m²/g to about 150 m²/g, about 60 m²/g to about 100 m²/g, or about 65 m²/g to about 70 m²/g.

The water based hydrophobic silica aerogel may have a fire resistant temperature in a range of about 250° C. to about 600° C.

The water based hydrophobic silica aerogel may have porosity in a range of about 20% to about 98%.

The water based hydrophobic aerogel may have contact angle in a range of about 90° to about 170°.

In another aspect, the present invention discloses a water based hydrophobic cellulose aerogel manufactured by a method as herein described. The method comprises firstly providing an aqueous mixture which comprises a water-based binder, fillers, fire retardant and a surfactant. A silyl-modified precursor comprising a cellulose system is added to the aqueous mixture to form an emulsion, after which a water soluble crosslinking agent is added to produce a gelled composite and in-situ water-based hydrophobic agent is added to the gelled composite under vacuum homogenizing and mixing conditions. The hydrophobized gelled composite is frozen and the frozen gelled composite is microwave assisted vacuum freeze dried at a pre-determined pressure and at a pre-determined temperature by inducing microwave rapid bulk heating throughout the gelled composite affected in the presence of vacuum sufficient for sublimation of ice to form a aerogel and then cured to form the hydrophobic cellulose aerogels and cellulose aerogel composites.

Advantageously, the water based hydrophobic cellulose aerogel can be produced at least on a large scale of about 800 mm by 1200 mm with a thickness of about 5 mm to about 100 mm and with good homogeneity and consistency, i.e. homogeneous distribution of all components throughout its cross-section. Advantageously, the water based hydrophobic aerogel can be produced on a large scale continuous process with a width of 500 mm to 1000 mm with a thickness of about 5 mm to about 100 mm and with good homogeneity and consistency.

The water based hydrophobic cellulose aerogel may further comprise a strengthening agent. The strengthening agent may be added in the aqueous mixture with the water-based binder and surfactant. This aqueous solution is mixed and processed similarly as mentioned above to give the water based hydrophobic cellulose aerogel. The degree of hydrophobicity may be varied by varying the amount and type of hydrophobic material (for example silane coupling material) as mentioned herein.

The water based hydrophobic cellulose aerogel may have a thermal conductivity in a range of about 0.010 W/mK to about 0.038 W/mK. For example, the water based hydrophobic cellulose aerogel may have a thermal conductivity of about 0.010 W/mK to about 0.038 W/mK, about 0.010 W/mK to about 0.035 W/mK, about 0.010 W/mK to about 0.030 W/mK, about 0.010 W/mK to about 0.024 W/mK, about 0.010 W/mK to about 0.022 W/mK, about 0.010 W/mK to about 0.020 W/mK, about 0.012 W/mK to about 0.026 W/mK, about 0.014 W/mK to about 0.026 W/mK, about 0.016 W/mK to about 0.026 W/mK, about 0.018 W/mK to about 0.026 W/mK, about 0.018 W/mK to about 0.024 W/mK, about 0.019 W/mK to about 0.023 W/mK or about 0.020 W/mK to about 0.022 W/mK.

The water based hydrophobic cellulose aerogel may have a density in a range of about 0.04 g/cm³ to about 0.15 g/cm³. For example, the water based hydrophobic aerogel may have a density of about 0.040 g/cm³ to about 0.15 g/cm³, about 0.050 g/cm³ to about 0.15 g/cm³, about 0.06 g/cm³ to about 0.145 g/cm³, about 0.07 g/cm³ to about 0.14 g/cm³, about 0.07 g/cm³ to about 0.135 g/cm³, about 0.07 g/cm³ to about 0.13 g/cm³, about 0.07 g/cm³ to about 0.125 g/cm³, about 0.07 g/cm³ to about 0.12 g/cm³, about 0.07 g/cm³ to about 0.115 g/cm³, about 0.075 g/cm³ to about 0.12 g/cm³, or about 0.08 g/cm³ to about 0.12 g/cm³.

The water based hydrophobic cellulose aerogel may have a compressive modulus in a range of about 0.1 MPa to about 40 MPa. For example, the water based hydrophobic cellulose aerogel may have a compressive modulus in a range of about 0.2 MPa to about 40 MPa, about 0.5 MPa to about 40 MPa, about 1 MPa to about 35 MPa, about 5 MPa to about 30 MPa, or about 10 MPa to about 25 MPa.

The water based hydrophobic cellulose aerogel may have a compressive strength in a range of about 0.05 MPa to about 4.5 MPa. For example, the water based hydrophobic cellulose aerogel may have a compressive strength at least about 0.1 MPa, about 0.2 MPa, about 0.5 MPa, about 1.0 MPa, about 1.5 MPa, about 2.0 MPa, about 3.0 MPa, about 3.8 MPa, about 4.0 MPa, or about 4.5 MPa.

The water based hydrophobic cellulose aerogel may have a specific surface area in a range of about 5 m²/g to about 300m²/g. For example, the water based hydrophobic cellulose aerogel may have a specific surface area in a range of about 5 m²/g to about 300m²/g, about 10 m²/g to about 300 m²/g, about 15 m²/g to about 300m²/g, about 20 m²/g to about 300m²/g, about 25 m²/g to about 300m²/g, about 30 m²/g to about 300m²/g, about 35 m²/g to about 300m²/g, about 40 m²/g to about 300m²/g, about 45 m²/g to about 250m²/g, about 50 m²/g to about 200 m²/g, about 55 m²/g to about 150 m²/g, about 60 m²/g to about 100 m²/g, or about 65 m²/g to about 70 m²/g.

The water based hydrophobic cellulose aerogel may have a fire resistant temperature in a range of about 250° C. to about 600° C.

The water based hydrophobic cellulose aerogel may have porosity in a range of about 20% to about 98%.

The water based hydrophobic cellulose aerogel may have water contact angle of in a range of about 90° to about 170°.

Accordingly, in another aspect, the present invention discloses a water based hydrophobic silica-cellulose aerogel comprising a cellulose material, silyl modified silica system, a surfactant, a water-based binder, hydrophobic agents and a crosslinking agent. The water based silica-cellulose hydrophobic aerogel has a homogeneous distribution of all components throughout its cross-section. Further, the water based silica-cellulose hydrophobic aerogel may be manufactured in a large size, for example at least about 800 mm by about 1200 mm. The water based hydrophobic silica-cellulose aerogel composite has at least the following properties: a density in a range of about 0.07 g/cm³ to about 0.13 g/cm³, a thermal conductivity in a range of about 0.010 W/mK to about 0.030 W/mK, compressive strength of 0.2 MPa, surface area of 45.5 m²/g, fire resistant of 350° C., water contact angle of 130° and porosity of 95%.

The surfactant used in the water based hydrophobic aerogel may be sodium dodecyl sulfate. The water-based binder may be gelatin, polyvinyl alcohol, acrylic, polyurethane, co-polymers of the above and the crosslinking agent may be glutaraldehyde, borate salts.

The water based hydrophobic silica-cellulose aerogel may further comprise an inorganic filler and a strengthening agent. The inorganic filler may be selected from a group comprising of: amorphous silica, zirconium dioxide, iron (Ill) oxide, titanium oxide, barium sulphate, fumed silica and borates of various types, for example zinc or a combination thereof. The strengthening agent may be selected from a group consisting of fumed silica, mineral fiber, calcium silicate, or a combination thereof.

Accordingly, in another aspect, the present invention discloses a water based hydrophobic silica-polymer aerogel comprising a polymeric material, silyl modified silica system, a surfactant, a water-based binder, hydrophobic agents and a crosslinking agent. The water based silica-cellulose hydrophobic aerogel has a homogeneous distribution of all components throughout its cross-section. Further, the water based silica-polymer hydrophobic aerogel may be manufactured in a large size, for example at least about 800 mm by about 1200 mm. The water based hydrophobic silica-polymer aerogel composite has at least the following properties: a density in a range of about 0.07 g/cm³ to about 0.20 g/cm³, a thermal conductivity in a range of about 0.018 W/mK to about 0.035 W/mK, compressive strength of 0.2 MPa, surface area of 45.5 m²/g, fire resistant of 350° C., water contact angle of 130° and porosity of 95%.

### Experimental Data

Commercially procured hydrophobic silica aerogel powder or granules or particles can be used as silica precursors to develop these composites in the present invention. Before modification, hydrophobic silica aerogel powder used in the examples described herein are white, opaque, with bulk density of 0.08-0.10 g/cm³, porosity of >90%, pore diameter ˜20 nm, surface area of 600-1500m²/g.

Additionally, commercially water-based organic polymers can be used as polymer precursors to develop the aerogels. The polymers are selected from emulsions or dispersions consisting of poly(meth)acrylic acid, poly(meth)acrylic ester, poly(meth)acrylamide, Polyurethane, vinyl chloride, styrene-acrylic copolymers, silicone-acrylic copolymers, biodegradable-acrylic copolymers, or a combination thereof.

Additionally, commercially procured microfilbirated cellulose can be used as cellulose precursors to develop the aerogel. The micro cellulose is processed and treated from recycled waste materials. The nominal size of the micro cellulose is 5˜7 μm in diameter, surface area of 100 m²/g and a density of 1.0 g/cm³.

Hydrophillic fumed silica is procured commercially as additive filler. The fumed silica has a pore diameter of 2.5 nm, particle size of 12 pm and a pore volume of 0.44 mL/g. High strength gelatin from bovine skin (bloom strength 260; density˜1.043 g/cm3) can be used in some of the embodiments. PVA with 80 to 86% hydrolysis in water can be used as a supplement binder in some embodiments. Water-based silicone binders can be used in some embodiments. Surfactant used is sodium dodecyl sulfate. Mineral Fibers, Basalt Fibers and Silica Fibers can be used as strengthening and fire resistant material. Titanium oxide can be used as an inorganic filler and opacifier. Silicon Carbide of particle sizes in the range of 2 to 36 microns and graphite in the range of 200 to 1000 nanometers can also be used as opacifiers for higher temperature applications. Zinc Borate and Boric acid can be used as fire retardant materials in some embodiments. Water can be used as main solvent. Ethanol is used as a complementary solvent in some embodiments. 1,4 dioxane is also used as a hydrolysis and condensation reaction medium in certain embodiments. Aluminium Fluoride can be used as a catalyst in some embodiment to speed up the reaction. Acids and bases can also be used sparingly in some of the embodiments as catalysts.

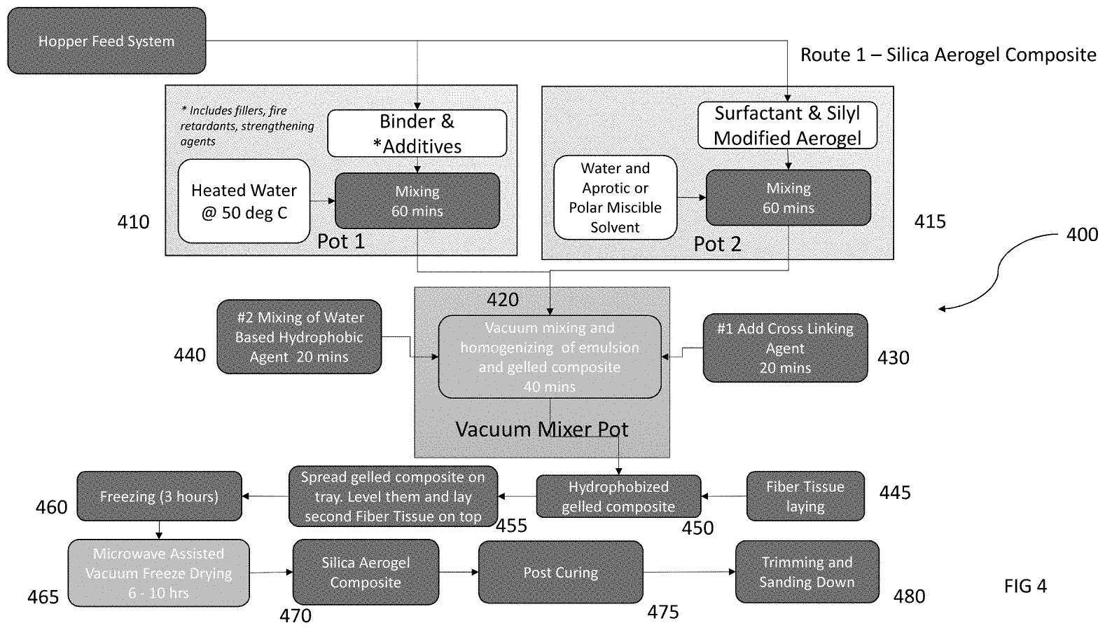

Referring to FIG. 4, there is shown a first embodiment of a method 400 for manufacturing a silica aerogel composite. Aqueous mixture with 7 to 8 wt % quantities of binder in water is prepared at 50° C. via mixing for 30 mins to dissolve the binder granulates in Mixing Pot 1. Power settings can be from 30 to 50%. Thereafter, various quantities of strengtheners, filler materials and fire retardants are added in Pot 1 for further mixing for 30 minutes (410). In Pot 2, 50 to 60 wt % of aerogel particles, surfactants, and ethanol in water are added into the mixture for mixing for 60 mins (415). The ratio of ethanol in water is about 1:10 to 1:20.

The mixture in Pots 1 and 2 are then transferred to a vacuum mixing and homogenizer. Under high shear homogenization at 2600 rpm and mixing at 60 rpm in vacuum conditions, both are mixed to form a second mixture as an emulsion (420). The addition of water based crosslinking agents (430) and hydrophobic agents (440) are carried out in 20-minute intervals. The total time taken is 100 mins. The hydrophobized gelled composite is transferred (450) on a tray laid with silica fiber tissue (445). The hydrophobized gelled composite is spread evenly throughout the tray and levelled evenly (455). Thereafter another layer of silica fiber tissue is laid on the surface.

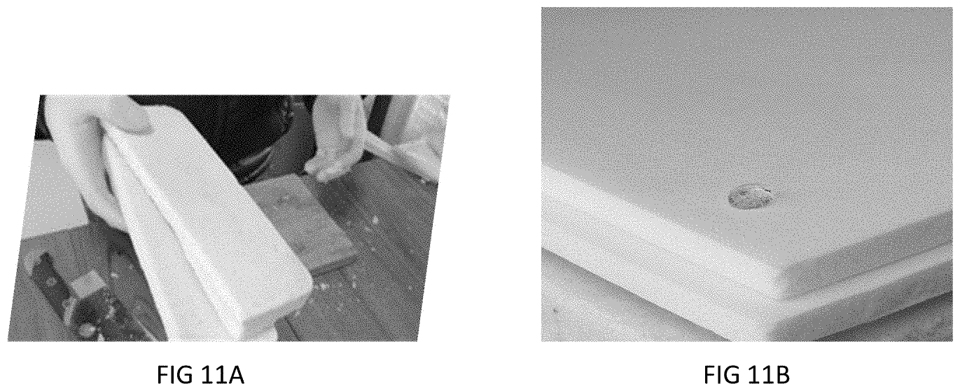

Let the silica hydrophobized gelled composite set for 1 hour at room temperature. Pre-freeze the silica hydrophobized gelled composite to harden the sample at −80° C. for 3 hours (460). After freezing, the frozen sample is inserted into microwave assisted vacuum freeze dryer (MAVFD). The fully frozen sample is then sublimated at a predetermined cold trap temperature −50° C. under vacuum for 6 to 10 hours till the moisture content reaches below 5% (465). The first pre-determined pressure is maintained at below 200 Pascals throughout the sublimation process. Full drying is achieved when the chamber pressure drops to below 50 Pascals and moisture drops close to below 5%. Weight sensors may be placed on the sample to monitor the real time moisture loss variations for tracking. IR thermal camera may be installed to capture temperature distribution profile images. The sample becomes water based hydrophobic silica aerogel composite at this point (470). After removing the sample, cure the sample for 2 to 6 hours at 60 to 110° C. to effect the full hydrophobicity of the aerogel (475). A fully cured sample will have approximately the same mass of all the raw materials in the composition. Trimming and sanding down is then carried out (480). An example of the fully cured sample is depicted in FIG. 11B which also shows hydrophobic properties in relation to the liquid droplet on the sample.

In the examples which follow, in accordance with the above described procedures, the ingredients were used in the amount indicated for a 600×600 ×27 mm panel as a ratio to the aerogel particles loadings. The aerogel loading ratio is all examples taken as 1.00.

### EXAMPLE 1

Table 1 illustrates an example of compositions usable in the method of manufacture as described herein. Inorganic fillers such as boric acid, titanium oxide, silica fibers and fumed silica can be used to modify the property of the silica aerogel composite.

TABLE 1

| Chemical | Ratio |
|---|---|
| Gelatin | 0.075 |
| Fumed Silica | 0.075 |
| Boric Acid | 0.025 |
| TiO2 | 0.051 |
| SDS | 0.005 |
| Silica Fibers | 0.050 |
| Organosilane A | 0.151 |
| Glutaraldehyde | 0.145 |
| Siloxane B | 0.302 |
| Water | 5.000 |

### EXAMPLE 2

Another example of a composition usable in the method of manufacture as described herein. Two complementary binders, gelatin and PVA were used as shown in Table 2. Non-ionic surfactant with a HLB index of 8.5 was used instead of SDS.

TABLE 2

| Chemical | Ratio |
|---|---|
| Gelatin | 0.063 |
| PVA | 0.045 |
| Biosoft Non Ionic Surfactant | 0.162 |
| TiO2 | 0.011 |
| Boric Acid | 0.0210 |
| Organosilane A | 0.122 |
| Glutaraldehyde | 0.118 |
| Siloxane B | 0.285 |
| Water | 4.064 |
| Ethanol | 0.128 |

### EXAMPLE 3

Table 3 illustrates other examples of compositions usable in the method of manufacture as described herein. A self crosslinking silicone binder, inorganic fillers such as zinc borate, titanium oxide, basalt fibers and fumed silica can be used to modify the property of the silica aerogel composite. The silica aerogel composites were able to resist a direct flame of above 1000° C., with the surface temperature of the silica aerogel composite reaching about 400° C. to about 600° C. without catching fire.

TABLE 3

| Chemical | Ratio |
|---|---|
| Silicon Resin | 0.407 |
| Fumed Silica | 2.300 |
| TiO2 | 0.029 |
| SDS | 0.011 |
| Zinc Borate | 0.100 |
| Calcium Silicate | 0.110 |
| Basalt Fibers | 0.110 |
| Organosilane A | 0.445 |
| Siloxane B | 1.050 |
| Water | 24.00 |
| Ethanol | 0.500 |

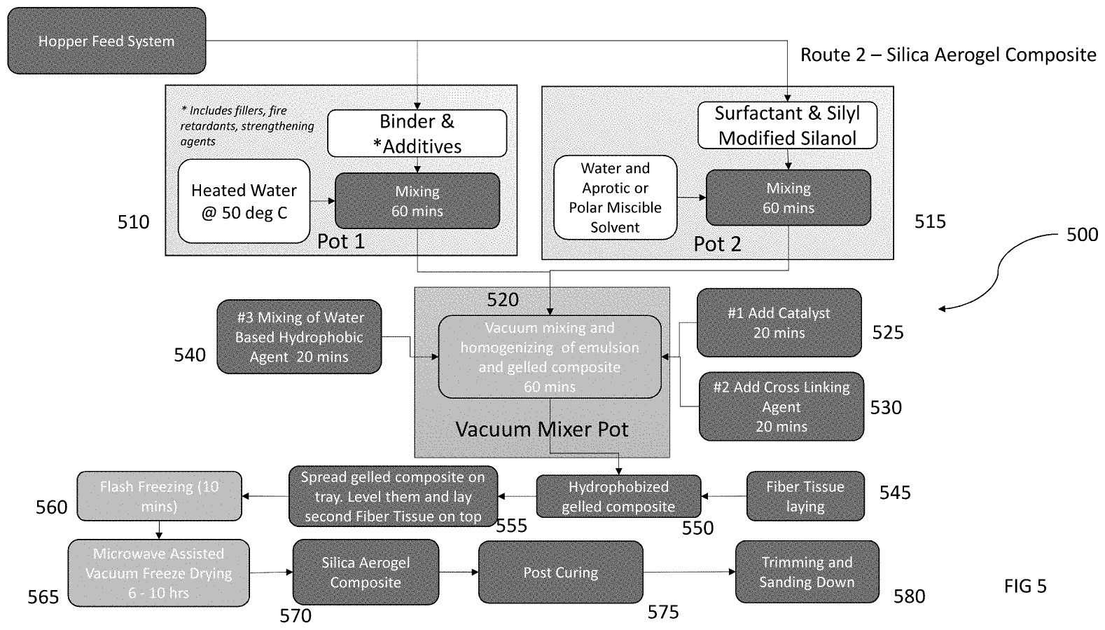

Referring to FIG. 5, there is shown a second embodiment of a method 500 for manufacturing a silica aerogel composite. Aqueous mixture with 7 to 8 wt % quantities of binder in water is prepared at 50° C. via mixing for 30 mins to dissolve the binder granulates 50 wt % silica micro fibers (dia 6.5 μm) in Mixing Pot 1. Power settings can be from 30 to 50%. Thereafter, various quantities of strengtheners, filler materials and fire retardants are added in Pot 1 for further mixing for 30 minutes (510). In Pot 2, 15 wt % of silane coupling agents such as methyltrimethoxysilane (MTMS), tetraethoxysilane (TEOS), polyethoxydisiloxane (PEDS), and Sodium silicate (Waterglass), and/or a combination thereof, surfactants and ethanol and/or isopropyl alcohol in water are added into the mixture for mixing for 60 mins (515). The ratio of ethanol in water is about 1:10 to 1:20.

The mixture in Pots 1 and 2 are then transferred to a vacuum mixing and homogenizer. Under high shear homogenization at 2600 rpm and mixing at 60 rpm in vacuum conditions, both are mixed to form a second mixture as an emulsion (520). The addition of catalyst (525), water based crosslinking agents (530) and hydrophobic agents (540) are carried out in 20-minute intervals. The total time taken is 120 mins. The hydrophobized gelled composite is transferred (550) on a tray laid with silica fiber tissue (545). The hydrophobized gelled composite is spread evenly throughout the tray and levelled evenly (555). Thereafter another layer of silica fiber tissue is laid on the surface.

Let the silica hydrophobized gelled composite set for 1 hour at room temperature. Pre-freeze the silica hydrophobized gelled composite to harden the sample by flash freezing using Liquid Nitrogen Freezing or alcohol Brine Freezing for 10 mins (560). The flash freezing would produce small ice crystals as compared to conventional freezing. After flash freezing, the frozen sample is inserted into microwave assisted vacuum freeze dryer (MAVFD). The fully frozen sample is then sublimated at a predetermined cold trap temperature −50° C. under vacuum for 6 to 10 hours till the moisture content reaches below 5% (565). The first pre-determined pressure is maintained at below 200 Pascals throughout the sublimation process. Full drying is achieved when the chamber pressure drops to below 50 Pascals and moisture drops close to below 5%. Weight sensors may be placed on the sample to monitor the real time moisture loss variations for tracking. IR thermal camera may be installed to capture temperature distribution profile images. The sample becomes water based hydrophobic silica aerogel composite at this point (570). After removing the sample, cure the sample for 2 to 6 hours at 60 to 150° C. to effect the full hydrophobicity of the aerogel (575). A fully cured sample will have approximately the same mass of all the raw materials in the composition. Trimming and sanding down is then carried out (580).

In the examples which follow, in accordance with the above described procedures, the ingredients were used in the amount indicated for a 600×600×27 mm panel as a ratio to the silane coupling agent loadings. The silane coupling agent loading ratio is all examples taken as 1.00

### EXAMPLE 4

Table 4 illustrates an example of compositions usable in the method of manufacture as described herein. The silyl modified precursor is TEOS with PVA as the water-based binder. Ammonium fluoride is the catalyst to affect gelation in the emulsified mixture and CTAB was the surfactant. Silica fibers are used as strengthening agent and titanium oxide as filler.

TABLE 4

| Chemical | Ratio |
|---|---|
| TEOS | 1.000 |
| Silica Fibers | 3.200 |
| PVA | 0.100 |
| TiO2 | 0.072 |
| CTAB | 0.033 |
| Ammonium Fluoride | 0.067 |
| Organosilane A | 0.593 |
| Glutaraldehyde | 0.200 |
| Siloxane B | 1.400 |
| Water | 32.00 |
| Ethanol | 0.670 |

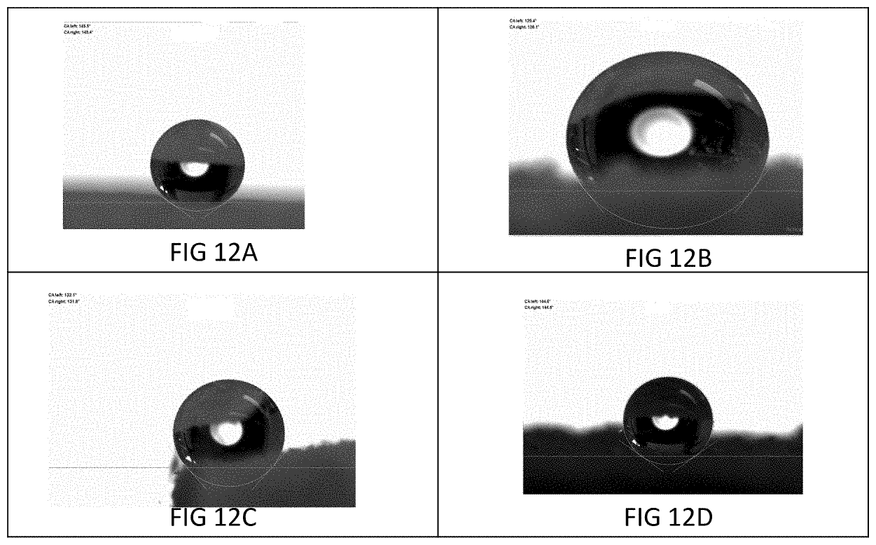

The test data from Examples 1 to 4 is shown in Table 5. The sample ID corresponds to each of the examples. For each example, at least two test data is provided. Additionally, FIG. 12-A to 12-D shows the contact angle measurements depicted in the above examples.

TABLE 5

| | | | | Water | |
|---|---|---|---|---|---|
| | | Thermal | Compressive | Contact | |
| | Density | Conductivity | Strength | Angle | Max Temp |
| Sample | (g/cm³) | (W/m-K) | (MPa) | (°) | (° C.) |
| 1-A | 0.1240 | 0.01940 | 0.12 | 145 | 350 |
| 1-B | 0.1274 | 0.01975 | 0.11 | 144 | 350 |
| 1-C | 0.1314 | 0.01934 | 0.12 | 144 | 352 |
| 1-D | 0.1307 | 0.01947 | 0.11 | 144 | 354 |
| 2-A | 0.0917 | 0.02057 | 0.115 | 129 | 350 |
| 2-B | 0.0921 | 0.02042 | 0.145 | 128 | 350 |
| 3-A | 0.1570 | 0.02551 | 1.24 | 132 | 620 |
| 3-B | 0.1640 | 0.02570 | 1.36 | 127 | 600 |
| 4-A | 0.1420 | 0.02612 | 1.06 | 144 | 500 |
| 4-B | 0.1400 | 0.02743 | 1.12 | 145 | 520 |

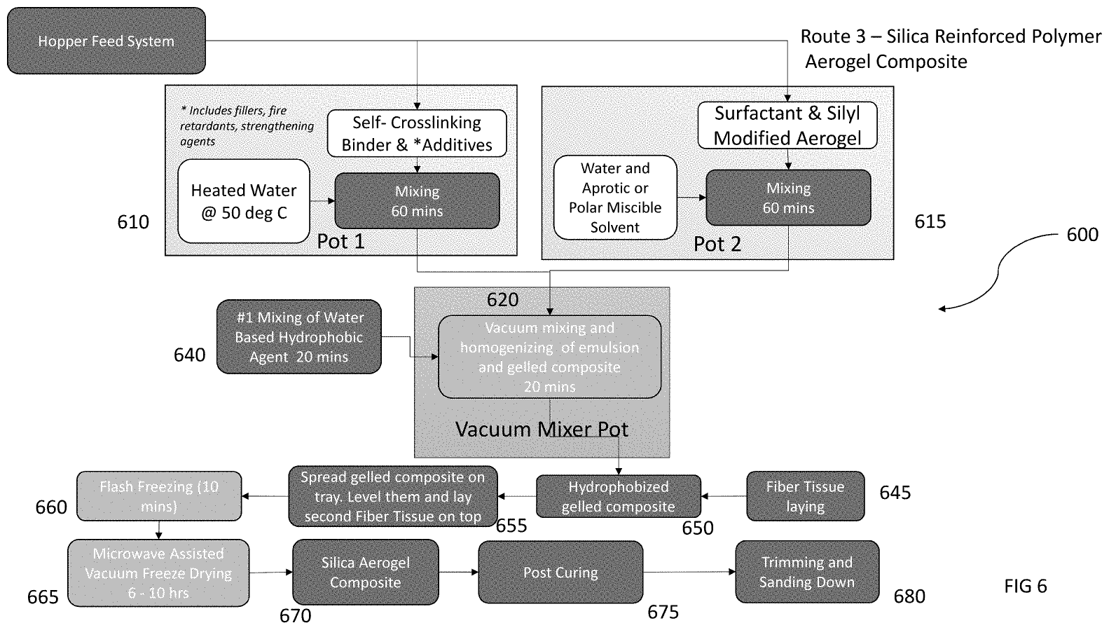

Referring to FIG. 6, there is shown a first embodiment of a method 600 for manufacturing a silica reinforced polymer aerogel composite. Aqueous mixture with 18 to 20 wt % quantities of at least one polymer or copolymer in water is prepared at 50° C. via mixing for 30 mins in Mixing Pot 1. Power settings can be from 30 to 50%. Thereafter, various quantities of strengtheners, filler materials and fire retardants are added in Pot 1 for further mixing for 30 minutes (610). In Pot 2, aerogel particles, surfactants, and ethanol in water are added into the mixture for mixing for 60 mins (615). The ratio of ethanol in water is about 1:10 to 1:20.

The mixture in Pots 1 and 2 are then transferred to a vacuum mixing and homogenizer. Under high shear homogenization at 2600 rpm and mixing at 60 rpm in vacuum conditions, both are mixed to form a second mixture as an emulsion (620). The addition of hydrophobic agents (640) are carried out in 20-minute intervals. The total time taken is 80 mins. The hydrophobized gelled composite is transferred (650) on a tray laid with silica fiber tissue (645). The hydrophobized gelled composite is spread evenly throughout the tray and levelled evenly (655). Thereafter another layer of silica fiber tissue is laid on the surface.

Let the silica reinforced polymer hydrophobized gelled composite set for 1 hour at room temperature. Pre-freeze the silica reinforced polymer hydrophobized gelled composite to harden the sample by flash freezing using Liquid Nitrogen Freezing or alcohol Brine Freezing for 10 mins (660). After flash freezing, the frozen sample is inserted into microwave assisted vacuum freeze dryer (MAVFD). The fully frozen sample is then sublimated at a predetermined cold trap temperature −50° C. under vacuum for 6 to 10 hours till the moisture content reaches below 5% (665). The first pre-determined pressure is maintained at below 200 Pascals throughout the sublimation process. Full drying is achieved when the chamber pressure drops to below 50 Pascals and moisture drops close to below 5%. Weight sensors may be placed on the sample to monitor the real time moisture loss variations for tracking. IR thermal camera may be installed to capture temperature distribution profile images. The sample becomes water based hydrophobic silica reinforced polymer aerogel composite at this point (670). After removing the sample, cure the sample for 2 to 6 hours at 60 to 110° C. to effect the full hydrophobicity of the aerogel (675). A fully cured sample will have approximately the same mass of all the raw materials in the composition. Trimming and sanding down is then carried out (680).

In the examples which follow, in accordance with the above described procedures, the ingredients were used in the amount indicated for a 600×600×27 mm panel as a ratio to the aerogel particles loadings. The aerogel loading ratio is all examples taken as 1.00.

### EXAMPLE 5

A silica reinforced polymer aerogel was developed to impart toughness in aerogel. The aerogel is made from silyl modified silica aerogel granules, fumed silica, graphite, self crosslinking acrylic precursor, boric acid and hydrophobic agent.

TABLE 6

| Chemical | Ratio |
|---|---|
| Acrylic binder | 1.500 |
| Fumed Silica | 0.750 |
| Graphite | 0.100 |
| Anionic Surfactant | 0.050 |
| Boric Acid | 0.050 |
| Siloxane B | 0.300 |
| Water | 10.00 |

### EXAMPLE 6

A silica reinforced polymer aerogel was developed to impart toughness in aerogel. The aerogel is made from silyl modified silica aerogel granules, fumed silica, titanium oxide, self crosslinking polyurethane precursor, boric acid and hydrophobic agent. Basalt fibers are added for strengthening effect.

TABLE 7

| Chemical | Ratio |
|---|---|
| Polyurethane binder | 2.000 |
| Fumed Silica | 0.500 |
| TiO2 | 0.200 |
| Anionic Surfactant | 0.050 |
| Boric Acid | 0.050 |
| Basalt Fibers | 0.100 |
| Organosilane A | 0.300 |
| Siloxane B | 0.600 |
| Water | 10.00 |

The test data from Examples 5 to 6 is shown in Table 8. The sample ID corresponds to each of the examples. For each example, at least two test data is provided.

TABLE 8

| | | | | Water | |
|---|---|---|---|---|---|
| | | Thermal | Compressive | Contact | |
| | Density | Conductivity | Strength | Angle | Max Temp |
| Sample | (g/cm³) | (W/m-K) | (MPa) | (°) | (° C.) |
| 5-A | 0.1382 | 0.0233 | 0.151 | 132.1 | 257 |
| 5-B | 0.1356 | 0.0235 | 0.147 | 129.4 | 270 |
| 6-A | 0.1587 | 0.0226 | 0.294 | 115.4 | 400 |
| 6-B | 0.1476 | 0.0213 | 0.303 | 110.8 | 400 |

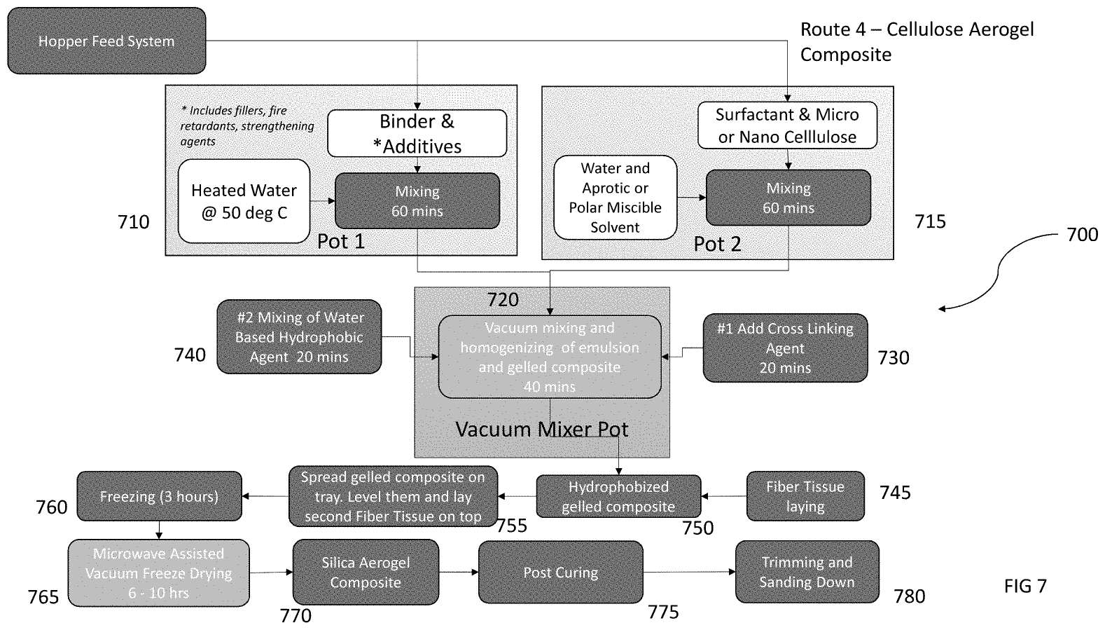

Referring to FIG. 7, there is shown a first embodiment of a method 700 for manufacturing a cellulose aerogel composite. Aqueous mixture with 9 to 10 wt % quantities of binder in water is prepared at 50° C. via mixing for 30 mins to dissolve the binder granulates in Mixing Pot 1. Power settings can be from 30 to 50%. Thereafter, various quantities of strengtheners, filler materials and fire retardants are added in Pot 1 for further mixing for 30 minutes (710). In Pot 2, cellulose micro fibers, surfactants, and ethanol/1,4 dioxane in water are added into the mixture for mixing for 60 mins ( 715. The ratio of ethanol in water is about 1:10 to 1:20.

The mixture in Pots 1 and 2 are then transferred to a vacuum mixing and homogenizer. Under high shear homogenization at 2600 rpm and mixing at 60 rpm in vacuum conditions, both are mixed to form a second mixture as an emulsion (720). The addition of water based crosslinking agents (730) and hydrophobic agents (740) are carried out in 20-minute intervals. The total time taken is 100 mins. The hydrophobized gelled composite is transferred (750) on a tray laid with silica fiber tissue (745). The hydrophobized gelled composite is spread evenly throughout the tray and levelled evenly (755). Thereafter another layer of silica fiber tissue is laid on the surface.

Let the cellulose hydrophobized gelled composite set for 1 hour at room temperature. Pre-freeze the cellulose hydrophobized gelled composite to harden the sample at −80° C. for 3 hours (760). After freezing, the frozen sample is inserted into microwave assisted vacuum freeze dryer (MAVFD). The fully frozen sample is then sublimated at a predetermined cold trap temperature −50° C. under vacuum for 6 to 10 hours till the moisture content reaches below 5% (765). The first pre-determined pressure is maintained at below 200 Pascals throughout the sublimation process. Full drying is achieved when the chamber pressure drops to below 50 Pascals and moisture drops close to below 5%. Weight sensors may be placed on the sample to monitor the real time moisture loss variations for tracking. IR thermal camera may be installed to capture temperature distribution profile images. The sample becomes water based hydrophobic cellulose aerogel composite at this point (770). After removing the sample, cure the sample for 2 to 6 hours at 60 to 110° C. to effect the full hydrophobicity of the aerogel (775). A fully cured sample will have approximately the same mass of all the raw materials in the composition. Trimming and sanding down is then carried out (780). An example of the fully cured sample is depicted in FIG. 11A.

In the examples which follow, in accordance with the above described procedures, the ingredients were used in the amount indicated for a 600×600×27 mm panel as a ratio to the cellulose micro fibers loadings. The cellulose micro fiber loading ratio is all examples taken as 1.00.

### EXAMPLE 7

A light weight hydrophobic cellulose aerogel was developed. The aerogel is made from cellulose micro fibers as precursor, fumed silica, titanium oxide, zinc borate, CTAB, SDS, PVA, glutaraldehyde as crosslinker.

TABLE 9

| Chemical | Ratio |
|---|---|
| PVA | 0.440 |
| TiO2 | 0.040 |
| Zinc Borate | 0.074 |
| CTAB | 0.018 |
| SDS | 0.093 |
| Ethanol | 0.370 |
| Organosilane A | 0.330 |
| Glutaraldehyde | 0.260 |
| Siloxane B | 0.780 |
| Water | 22.97 |
| 1,4 dioxane | 2.000 |

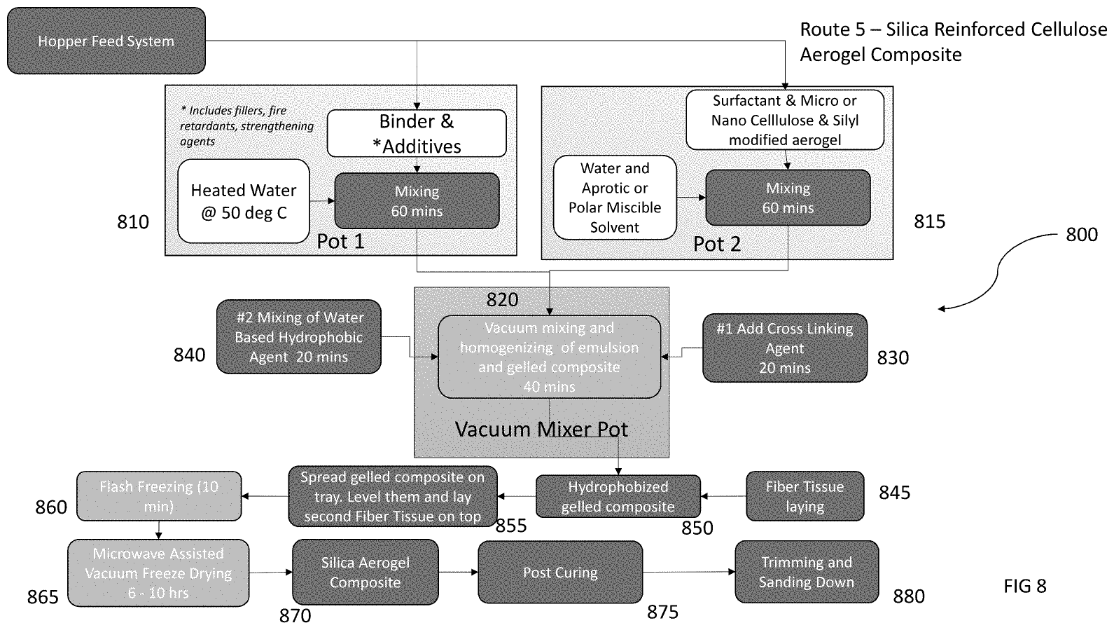

Referring to FIG. 8, there is shown a first embodiment of a method 800 for manufacturing a silica reinforced cellulose aerogel composite. Aqueous mixture with 9 to 10 wt % quantities of binder in water is prepared at 50° C. via mixing for 30 mins to dissolve the binder granulates in Mixing Pot 1. Power settings can be from 30 to 50%. Thereafter, various quantities of strengtheners, filler materials and fire retardants are added in Pot 1 for further mixing for 30 minutes (810). In Pot 2, cellulose micro fibers, silica aerogel, surfactants, and ethanol/1,4 dioxane in water are added into the mixture for mixing for 60 mins (815). The ratio of ethanol in water is about 1:10 to 1:20.

The mixture in Pots 1 and 2 are then transferred to a vacuum mixing and homogenizer. Under high shear homogenization at 2600 rpm and mixing at 60 rpm in vacuum conditions, both are mixed to form a second mixture as an emulsion (820). The addition of water based crosslinking agents (830) and hydrophobic agents (840) are carried out in 20-minute intervals. The total time taken is 100 mins. The hydrophobized gelled composite is transferred (850) on a tray laid with silica fiber tissue (845). The hydrophobized gelled composite is spread evenly throughout the tray and levelled evenly (855). Thereafter another layer of silica fiber tissue is laid on the surface.

Let the silica reinforced cellulose hydrophobized gelled composite set for 1 hour at room temperature. Pre-freeze the silica reinforced cellulose hydrophobized gelled composite to harden the sample by flash freezing using Liquid Nitrogen Freezing or alcohol Brine Freezing for 10 mins (860). After flash freezing, the frozen sample is inserted into microwave assisted vacuum freeze dryer (MAVFD). The fully frozen sample is then sublimated at a predetermined cold trap temperature −50° C. under vacuum for 6 to 10 hours till the moisture content reaches below 5% (865). The first pre-determined pressure is maintained at below 200 Pascals throughout the sublimation process. Full drying is achieved when the chamber pressure drops to below 50 Pascals and moisture drops close to below 5%. Weight sensors may be placed on the sample to monitor the real time moisture loss variations for tracking. IR thermal camera may be installed to capture temperature distribution profile images. The sample becomes water based hydrophobic silica reinforced cellulose aerogel composite at this point (870). After removing the sample, cure the sample for 2 to 6 hours at 60 to 110° C. to effect the full hydrophobicity of the aerogel (875). A fully cured sample will have approximately the same mass of all the raw materials in the composition. Trimming and sanding down is then carried out (880).

In the examples which follow, in accordance with the above described procedures, the ingredients were used in the amount indicated for a 600 33 600×27 mm panel as a ratio to the aerogel particles loadings.

The aerogel loading ratio is all examples taken as 1.00.

### EXAMPLE 8

A silica reinforced cellulose aerogel composite developed for lower thermal conductivity as compared with Example 7.

TABLE 10

| Chemical | Ratio |
|---|---|
| Cellulose Micro Fibers | 3.000 |
| PVA | 1.800 |
| Fumed Silica | 1.000 |
| TiO2 | 0.110 |
| Zinc Borate | 0.200 |
| Cationic Surfactant | 0.250 |
| Glutaraldehyde | 0.690 |
| Siloxane B | 0.50 |
| Water | 50.00 |
| 1,4 dioxane | 2.000 |

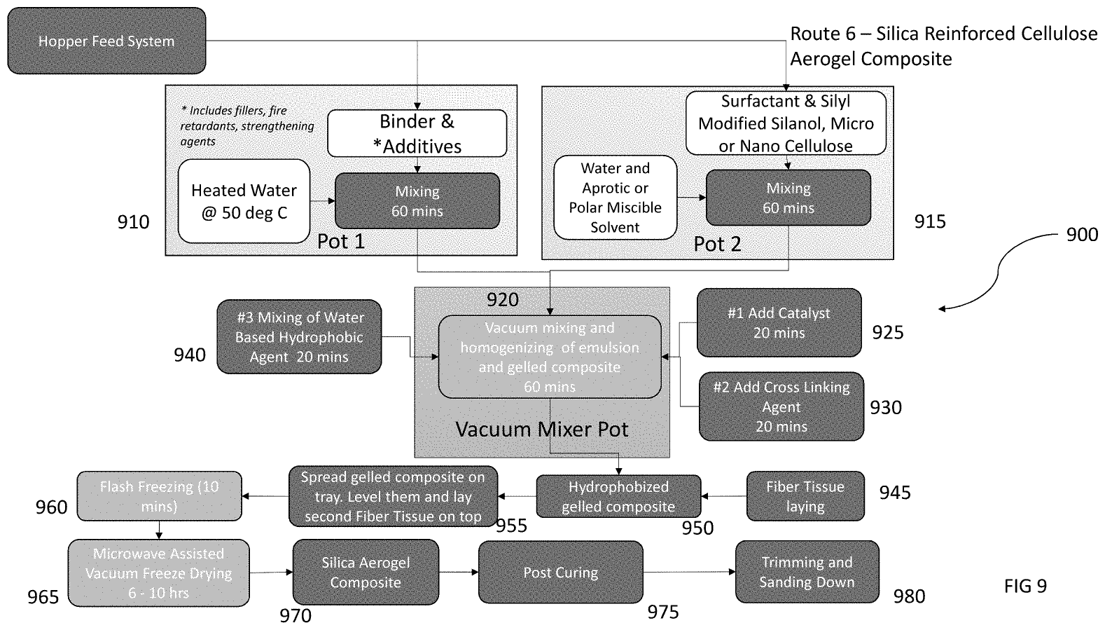

Referring to FIG. 9, there is shown a second embodiment of a method 900 for manufacturing a silica reinforced cellulose aerogel composite. Aqueous mixture with 9 to 10 wt % quantities of binder in water is prepared at 50° C. via mixing for 30 mins to dissolve the binder granulates in Mixing Pot 1. Power settings can be from 30 to 50%. Thereafter, various quantities of strengtheners, filler materials and fire retardants are added in Pot 1 for further mixing for 30 minutes (910). In Pot 2, cellulose micro fibers, silane precursors such as methyltrimethoxysilane (MTMS), tetraethoxysilane (TEOS), polyethoxydisiloxane (PEDS), and Sodium silicate (Waterglass), and/or a combination thereof, surfactants, and ethanol/1,4 dioxane in water are added into the mixture for mixing for 60 mins (915). The ratio of ethanol in water is about 1:10 to 1:20.

The mixture in Pots 1 and 2 are then transferred to a vacuum mixing and homogenizer. Under high shear homogenization at 2600 rpm and mixing at 60 rpm in vacuum conditions, both are mixed to form a second mixture as an emulsion (920). The addition of catalyst (925), water based crosslinking agents (930) and hydrophobic agents (940) are carried out in 20-minute intervals. The total time taken is 120 mins. The hydrophobized gelled composite is transferred (950) on a tray laid with silica fiber tissue (945). The hydrophobized gelled composite is spread evenly throughout the tray and levelled evenly (955). Thereafter another layer of silica fiber tissue is laid on the surface.

Let the silica reinforced cellulose hydrophobized gelled composite set for 1 hour at room temperature. Pre-freeze the silica reinforced cellulose hydrophobized gelled composite to harden the sample by flash freezing using Liquid Nitrogen Freezing or alcohol Brine Freezing for 10 mins (960). After flash freezing, the frozen sample is inserted into microwave assisted vacuum freeze dryer (MAVFD). The fully frozen sample is then sublimated at a predetermined cold trap temperature −50° C. under vacuum for 6 to 10 hours till the moisture content reaches below 5% (965). The first pre-determined pressure is maintained at below 200 Pascals throughout the sublimation process. Full drying is achieved when the chamber pressure drops to below 50 Pascals and moisture drops close to below 5%. Weight sensors may be placed on the sample to monitor the real time moisture loss variations for tracking. IR thermal camera may be installed to capture temperature distribution profile images. The sample becomes water based hydrophobic silica reinforced cellulose aerogel composite at this point (970). After removing the sample, cure the sample for 2 to 6 hours at 60 to 110° C. to effect the full hydrophobicity of the aerogel (975). A fully cured sample will have approximately the same mass of all the raw materials in the composition. Trimming and sanding down is then carried out (980).

In the examples which follow, in accordance with the above described procedures, the ingredients were used in the amount indicated for a 600×600 '27 mm panel as a ratio to the silane coupling agent loadings. The silane precursors loading ratio is all examples taken as 1.00.

### EXAMPLE 9

TABLE 11

| Chemical | Ratio |
|---|---|
| Cellulose Micro Fibers | 3.000 |
| PVA | 1.800 |
| TEOS | 1.000 |
| TiO2 | 0.108 |
| Zinc Borate | 0.200 |
| CTAB | 0.250 |
| Dioxane solution | 2.00 |
| glutaraldehyde | 0.690 |
| Siloxane B | 0.500 |
| Ammonium Fluoride | 0.050 |
| Water | 50.00 |

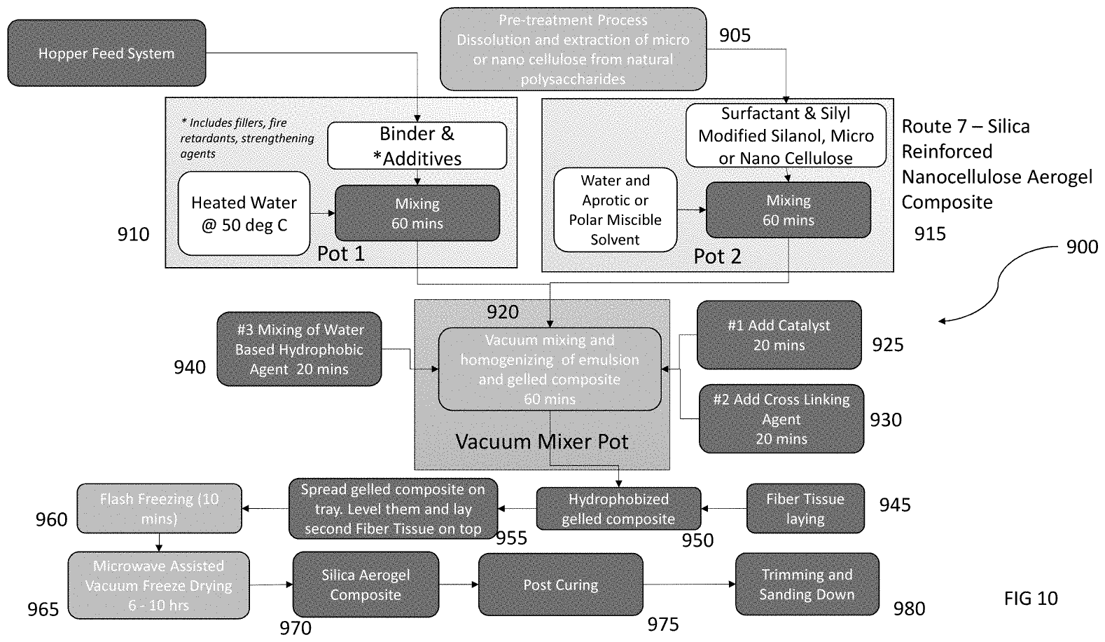

FIG. 10 is a substantially identical method 900 to FIG. 9 except for a pre-treatment process of microcellulose fibers (905). All labelling for FIG. 9 applies for FIG. 10. The pre-treatment allows the cellulose to restructure from micro to nano in the presence of acid-base treatment. Thus only the pre treatment process is explained here. 300 g of microcellulose were slowly added to 85 wt % orthophosphoric acid 300 ml in 500 ml distilled water. The mixture was stirred at 200 rpm under cold bath (−20° C.) under a mixer till it turned viscous liquid. The viscous liquid was later treated with Na+ion exchange resin to change the pH from 2 to 8. The mixture was regenerated with 300% water and finally washed with ethanol to get nanostructured cellulose.

### EXAMPLE 10

The sample prepared as per Example 9 except for the pretreatment process as explained in FIG. 10.

The test data from Examples 7 to 10 is shown in Table 12. The sample ID corresponds to each of the examples. For each example, at least two test data is provided.

TABLE 12

| | | | | Water | |
|---|---|---|---|---|---|
| | | Thermal | Compressive | Contact | |
| | Density | Conductivity | Strength | Angle | Max Temp |
| Sample | (g/cm³) | (W/m-K) | (MPa) | (°) | (° C.) |
| 7-A | 0.075 | 0.0360 | 0.092 | 115 | 320 |
| 7-B | 0.082 | 0.0352 | 0.089 | 121 | 330 |
| 8-A | 0.082 | 0.0332 | 0.109 | 126 | 350 |
| 8-B | 0.086 | 0.0338 | 0.110 | 129 | 350 |
| 9-A | 0.075 | 0.0341 | 0.123 | 135 | 370 |
| 9-B | 0.068 | 0.0332 | 0.118 | 135 | 370 |
| 10-A | 0.065 | 0.0362 | 0.150 | 130 | 370 |
| 10-B | 0.062 | 0.0349 | 0.150 | 134 | 370 |

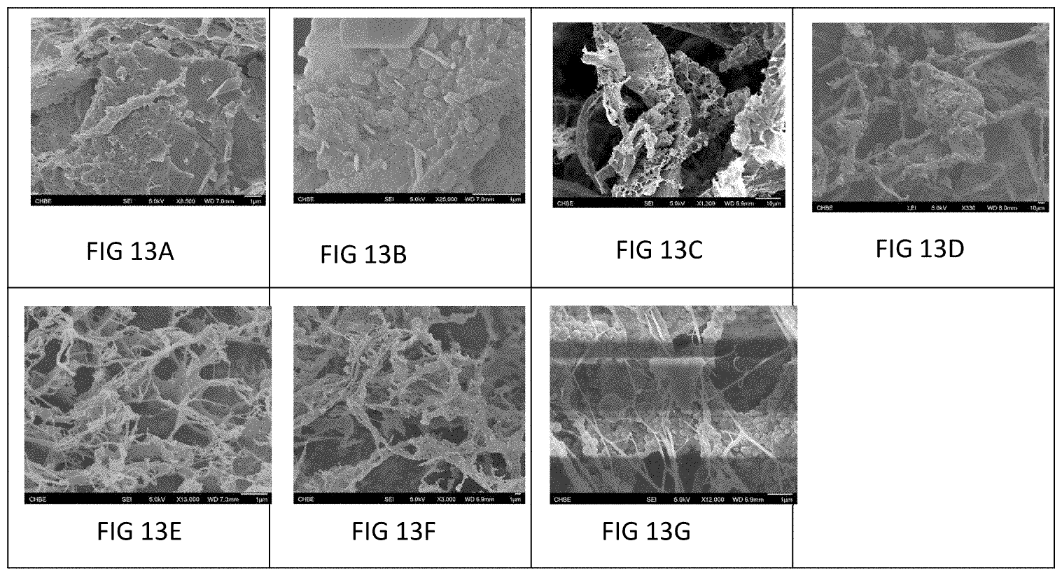

It should be appreciated that FIG. 13 shows examples of microstructural images of the methods of FIGS. 1 to 7. For the sake of clarity, FIG. 13A corresponds with the method of FIG. 4, FIG. 13B corresponds with the method of FIG. 5, FIG. 13C corresponds with the method of FIG. 6, FIG. 13D corresponds with the method of FIG. 7, FIG. 13E corresponds with the method of FIG. 8, FIG. 13F corresponds with the method of FIG. 9, FIG. 13G corresponds with the method of FIG. 10. It should be appreciated that their appearance would define the properties of the end products.

The invention described herein is susceptible to variations and modifications other than those specifically described. It is to be understood that the invention includes all such variations and modifications which fall within the spirit and scope. The invention also includes all of the steps, features, compositions and compounds referred to or indicated in this specification, individually or collectively, and any and all combinations of any two or more of said steps or features.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

As used herein, the term “and/or” includes any and all combinations of one or more of the associated listed items. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

1. A method for manufacturing water-based hydrophobic aerogels and aerogel composites, the method comprising:
synthesizing an aqueous binder mixture;
adding silyl modified precursors to form an emulsion;
forming a gelled composite under vacuum homogenizing conditions;
treating the gelled composite hydrophobically in-situ under vacuum conditions;
freezing the gelled composite;
microwave assisted vacuum freeze-drying the gelled composite to form an aerogel composite; and
curing the aerogel composite,
wherein the microwave assisted vacuum freeze drying is configured to induce bulk drying of the gelled composite.

2. The method of claim 1, wherein the aqueous mixture includes fire retardants, inorganic fillers, surfactants and a strengthening agent.

3. The method of claim 1, wherein the microwave assisted vacuum freeze-drying is carried out using a microwave assisted vacuum freeze dryer.

4. The method of claim 1, wherein the silyl modified precursors are prepared from a process selected from a group consisting of: sol-gel techniques, emulsion techniques, and phase transfer techniques.

5. (canceled)

6. The method of claim 1, further including an infused step, wherein the infused step includes adding a water based hydrophobic material.

7. The method of claim 1, wherein the gelled composite is formed by adding a water soluble crosslinking agent.

8. A water-based hydrophobic aerogels and aerogel composites manufactured by a method comprising:
synthesizing an aqueous binder mixture;
adding silyl modified precursors to form an emulsion;
forming a gelled composite under vacuum homogenizing conditions;
treating the gelled composite hydrophobically in-situ under vacuum conditions;
freezing the gelled composite;
microwave assisted vacuum freeze-drying the gelled composite to form an aerogel composite; and
curing the aerogel composite,
wherein the microwave assisted vacuum freeze-drying is configured to induce bulk drying of the gelled composite.

9. The water-based hydrophobic aerogels and aerogel composites of claim 8, wherein the aqueous mixture includes fire retardants, inorganic fillers, surfactants and a strengthening agent.

10. The water-based hydrophobic aerogels and aerogel composites of claim 8, wherein the microwave assisted vacuum freeze-drying is carried out using a microwave assisted vacuum freeze dryer.

11. The water-based hydrophobic aerogels and aerogel composite of claim 8, wherein the silyl modified precursors are prepared from a process selected from a group consisting of: sol-gel techniques, emulsion techniques, and phase transfer techniques.

12. The water-based hydrophobic aerogels and aerogel composite of claim 8, the method further including an infused step, wherein the infused step includes adding a water based hydrophobic material.

13. (canceled)

14. The water-based hydrophobic aerogels and aerogel composite of claim 8, wherein the gelled composite is formed by adding a water soluble crosslinking agent.

15. A water based hydrophobic aerogel composite comprising:
a silyl modified aerogel precursor system;
a surfactant;
fire retardants;
hydrophobic agent; and
a crosslinking agent,
wherein components are homogeneously distributed, and being fabricated by the method of claim 1.

16. The aerogel composite of claim 15, being formed in a manner which exhibits minimal shrinkage and densification.

17. The aerogel composite of wherein the silyl modified aerogel precursor system is at least one selected from a group consisting of: silica, polysaccharide and a water-based polymers.
